(19) United States
(12) Patent Application Publication
(10) Pub. No.: US 2026/0342151 A1
(43) Pub. Date: Oct. 29, 2026

(54) Tri-Rotor Generator

(71) Applicant: Raymond A. Suda, Sterling Heights, MI (US)

(72) Inventor: Raymond A. Suda, Sterling Heights, MI (US)

(21) Appl. No.: 19/637,365

(22) Filed: Apr. 2, 2026

Related U.S. Application Data
(63) Continuation-in-part of application No. 19/327,407, filed on Sep. 12, 2025.
(60) Provisional application No. 63/796,671, filed on Apr. 29, 2025.

(51) Int. Cl. H02K 1/22; H02K 7/18; H02K 11/33; H02P 9/02; H02P 101/15

(52) U.S. Cl. CPC H02K 1/223; H02K 7/183; H02K 11/33; H02P 9/02; H02P 2101/15

(57) ABSTRACT

A generator includes a first magnetic field assembly, a second magnetic field assembly, a coil assembly, and control circuitry. The first magnetic field assembly includes one or more electromagnets. The coil assembly includes one or more coils and is disposed between the first magnetic field assembly and the second magnetic field assembly. The control circuitry is configured to apply current to the first magnetic field assembly to generate a rotating magnetic field relative to the coil assembly.

### CROSS-REFERENCE TO RELATED APPLICATION(S)

This application is a continuation-in-part of U.S. application Ser. No. 19/327,407, filed Sep. 12, 2025, which claims priority to and the benefit of U.S. Provisional Patent Application Ser. No. 63/796,671, filed Apr. 29, 2025, the entire disclosures of which are hereby incorporated by reference.

### TECHNICAL FIELD

This disclosure relates to electric generators, specifically, a tri-rotor generator with counter rotating rotors.

### BACKGROUND

Electric generators convert mechanical energy into electrical energy through the principle of electromagnetic induction. According to Faraday's Law, an electromotive force (emf) is induced in a conductor when the magnetic flux through the conductor changes over time, expressed mathematically as emf=−dΦ_{B}/dt, where Φ_{B} is the magnetic flux. In practical applications, this is often achieved by rotating magnets near coils of wire, or vice versa, which causes the magnetic field through the coils to vary. This changing magnetic field induces a current in the wire, thereby generating electricity.

In traditional electric generators, the conversion of mechanical to electrical energy involves a rotor and a stator. The rotor, which is mechanically driven, contains either permanent magnets or electromagnets and rotates within or around the stator. The stator is composed of coils of conductive wire, usually copper, arranged to form a stationary magnetic circuit. As the rotor spins, its magnetic field sweeps across the coils, causing a continuous change in magnetic flux through the coils, which induces an alternating current (AC) in the coils.

### SUMMARY

A first aspect of the disclosed implementations is a generator, including a first magnetic field assembly including one or more electromagnets, a second magnetic field assembly, a coil assembly including one or more coils, wherein the coil assembly is disposed between the first magnetic field assembly and the second magnetic field assembly, and control circuitry configured to apply current to the first magnetic field assembly to generate a rotating magnetic field relative to the coil assembly.

In some aspects, the second magnetic field assembly includes one or more electromagnets, and the control circuitry is further configured to apply current to the second magnetic field assembly to generate a magnetic field that combines with the rotating magnetic field relative to the coil assembly.

In some aspects, the second magnetic field assembly is a magnetic rotor including one or more permanent magnets.

In some aspects, the control circuitry is configured to adjust at least one of a phase or a frequency of the current based on an angular position of the magnetic rotor.

In some aspects, the coil assembly is a coil rotor configured to rotate in a direction opposite a direction of the rotating magnetic field.

In some aspects, the control circuitry is configured to adjust at least one of a phase or a frequency of the current based on an angular position of the coil rotor.

In some aspects, the coil assembly is a coil rotor selectively configurable between a stationary mode in which the coil assembly is fixed relative to a housing and a rotational mode in which the coil assembly rotates relative to the first magnetic field assembly to increase a relative rotational speed between the coil assembly and the rotating magnetic field.

In some aspects, the control circuitry is configured to synchronize a frequency and a phase of a voltage induced in the coil assembly with an external electrical system.

In some aspects, the control circuitry is configured to adjust an amplitude of the current to regulate an amplitude of a voltage induced in the coil assembly.

A second aspect of the disclosed implementations is a system including a generator. The generator includes a magnetic rotor including one or more magnetic field sources, a magnetic field assembly including one or more electromagnets, and a coil assembly disposed between the magnetic rotor and the magnetic field assembly. The coil assembly includes one or more coils electrically couplable to an external electrical system. The system further includes a rotational control system configured to control rotation of the magnetic rotor to synchronize a frequency and a phase of a voltage induced in the one or more coils with the external electrical system. The system further includes control circuitry configured to apply current to the magnetic field assembly to synchronize an amplitude of the voltage induced in the one or more coils with the external electrical system.

In some aspects, the system further includes a phase-locked loop configured to receive an input signal from the external electrical system and output a frequency and a phase to the rotational control system.

In some aspects, the coil assembly is a coil rotor, and the rotational control system is configured to rotate the coil rotor in a direction opposite a direction of rotation of the magnetic rotor.

In some aspects, the coil assembly is a coil rotor selectively configurable between a stationary mode in which the coil assembly is fixed relative to the magnetic rotor and a rotational mode in which the coil assembly rotates relative to the magnetic field assembly to increase a relative rotational speed between the coil assembly and a rotating magnetic field generated by the one or more electromagnets.

In some aspects, the rotational control system receives rotational energy from an external rotation source.

In some aspects, the external rotation source is a wind turbine.

In some aspects, the rotational control system is an electronic continuously variable transmission.

In some aspects, the external electrical system is an electrical grid.

A third aspect of the disclosed implementations is a method of operating a generator including a magnetic rotor, a coil rotor, and one or more electromagnets. The method includes rotating the magnetic rotor in a first direction, injecting, into the one or more electromagnets, time-varying currents to generate a rotating magnetic field in the first direction relative to the coil rotor, sensing an angular position of the magnetic rotor, and adjusting, based on the angular position of the magnetic rotor, at least one of a phase or a frequency of the time-varying currents.

In some aspects, the method further includes rotating the coil rotor in a second direction, and sensing an angular position of the coil rotor, wherein adjusting at least one of the phase or the frequency of the time-varying currents is based on the angular position of the coil rotor.

In some aspects, the method further includes adjusting an amplitude of the time-varying currents to regulate an amplitude of a voltage induced in the coil rotor.

These aspects and other implementations and variations in the aspects are described in additional detail below.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a first view of a radial configuration of a tri-rotor generator.

FIG. 2 is a second view of the tri-rotor generator of FIG. 1.

FIG. 3 is a third view of the tri-rotor generator of FIG. 1.

FIG. 4 is an exploded view of the tri-rotor generator of FIG. 1.

FIG. 5 is the tri-rotor generator of FIG. 1 including a gear box.

FIGS. 6A and 6B are exploded views of the tri-rotor generator of FIG. 1 including the gear box.

FIG. 7 is a first view of an axial configuration of the tri-rotor generator.

FIG. 8 is an exploded view of the tri-rotor generator of FIG. 7.

FIG. 9 is the tri-rotor generator of FIG. 7 including a planetary gear assembly.

FIG. 10 is an exploded view of the tri-rotor generator of FIG. 7 including the planetary gear assembly.

FIG. 11 is a cross-section of the tri-rotor generator including electromagnets.

FIG. 12 is a cross-section of the tri-rotor generator illustrating a magnetic field.

FIG. 13 is a current waveform that may be injected into an electromagnet.

FIG. 14 is a current digitized waveform that may be injected into an electromagnet.

FIG. 15 is a cross-section of the tri-rotor generator including electromagnets.

FIG. 16 is a cross-section of the tri-rotor generator including electromagnets.

FIG. 17 is a system including the tri-rotor generator.

FIG. 18 illustrates a shape of an electromagnet.

FIG. 19 is a flowchart of a method of operating a tri-rotor generator.

### DETAILED DESCRIPTION

Faraday's Law provides that the electromotive force produced in a coil of wire is equal to the rate of change of the magnetic flux. Increasing the rate of change of the magnetic flux will increase the voltage produced in the coil of wire. The rate of change of the magnetic flux may be increased by increasing the rotational speed of the magnets with respect to the coils of wire. In a traditional electric generator, increasing the rotational speed of the magnets with respect to the coils of wire would require increasing the rotational speed of the rotor with respect to the stator.

The power produced by the generator is equal to the voltage (V) squared, divided by the resistance (R) of the coils of wire. The resistance of the coils of wire remains constant. Thus, increasing the voltage produced in the coil of wire will increase the power produced by the generator. It may be desirable to increase the power produced by the generator without increasing the mass of the generator.

Accordingly, a tri-rotor generator is described. The tri-rotor generator includes a first rotor containing either permanent magnets or electromagnets (e.g., a first magnetic rotor), a second rotor containing the coils of wire (e.g., a coil rotor), and a third rotor containing either permanent magnets or electromagnets (e.g., a second magnetic rotor). By rotating the magnets past the coils of wire (e.g., rotating the first rotor and the third rotor in a clockwise direction) while simultaneously rotating the coils of wire in an opposite direction (e.g., rotating the second rotor in a counterclockwise direction), the rotational speed of the magnets with respect to the coils of wire can be increased. Thus, the tri-rotor generator may increase the rate of change of the magnetic flux without increasing mass. The tri-rotor generator may produce more power than a traditional generator of the same mass.

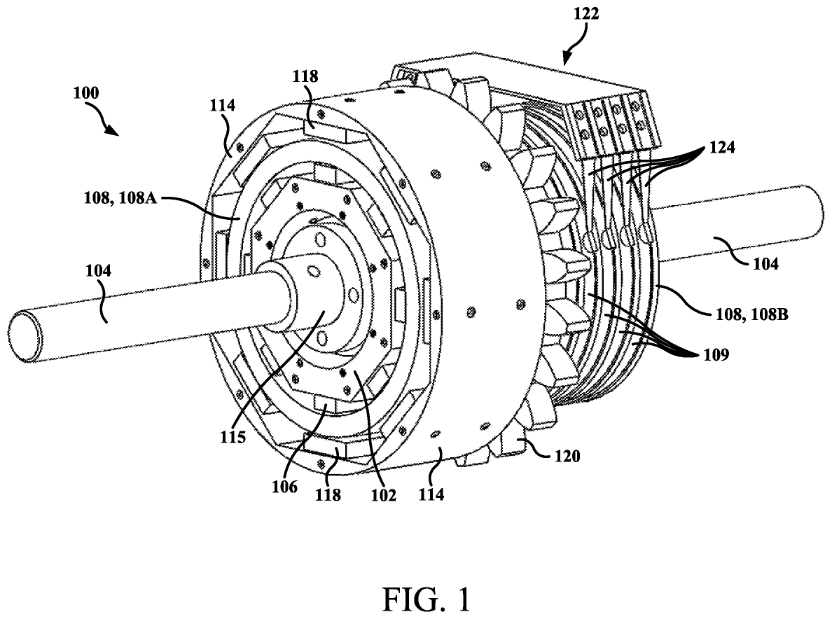

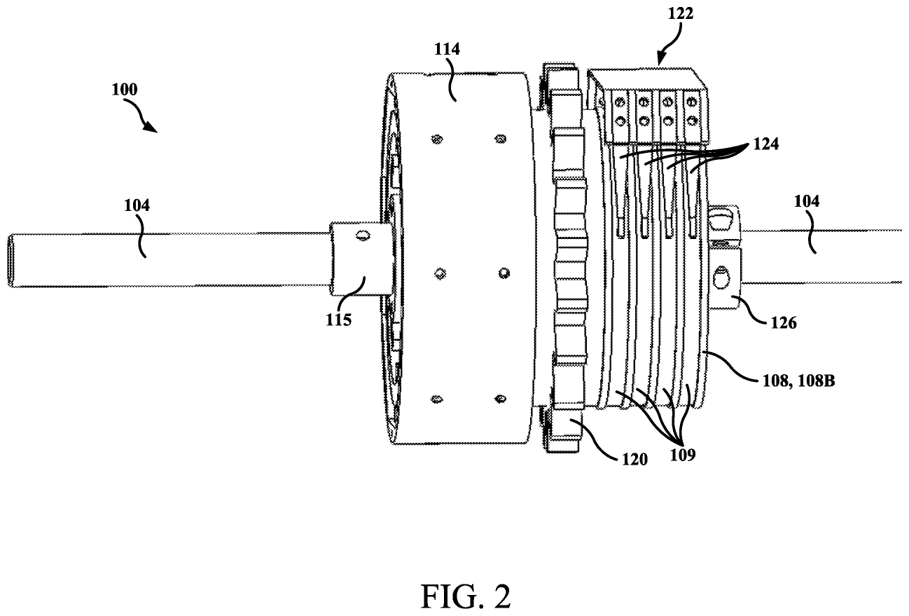

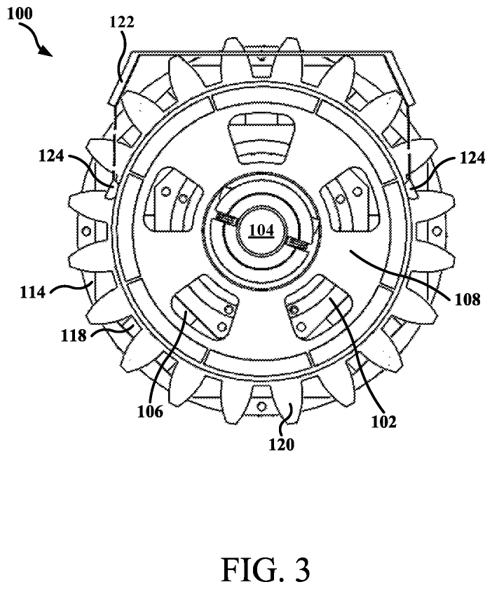

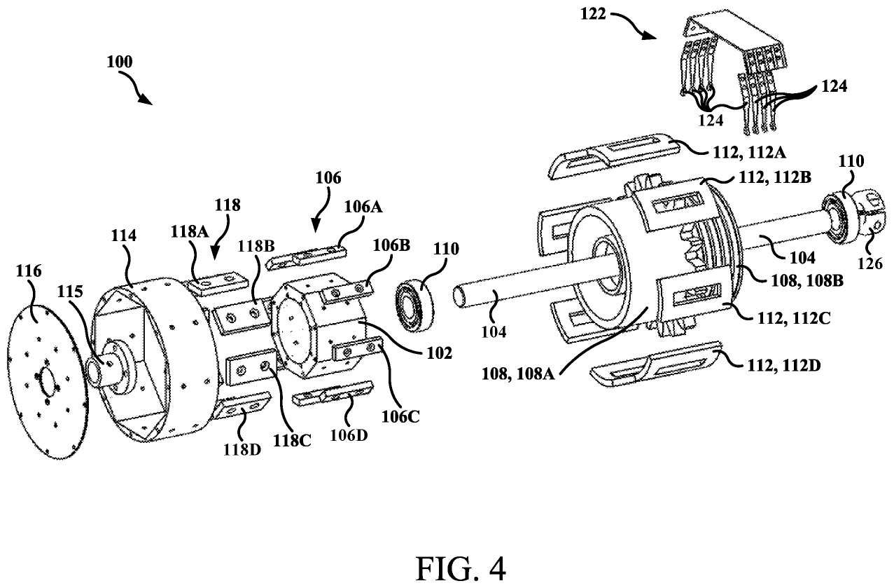

Referring to FIGS. 1 to 4, a first implementation (e.g., a radial configuration) of a tri-rotor generator 100 is shown. The tri-rotor generator 100 may include a case (e.g., a housing, container, cover, or the like) containing components of the tri-rotor generator 100. For ease of understanding, the case is omitted from FIGS. 1 to 4. The tri-rotor generator 100 may include a first magnetic rotor 102 rotationally connected to a shaft 104. In the first implementation of the tri-rotor generator 100, the first magnetic rotor 102 may be, for example, an inner rotor. The first magnetic rotor 102 may be rotated by the shaft 104, that is, a rotational force applied to the shaft 104 may drive the first magnetic rotor 102. Rotational force may be applied to the shaft 104 using, for example, a first motor. The first magnetic rotor 102 may be made from metal, for example, steel. The first magnetic rotor 102 may include one or more inner magnets 106. The inner magnets 106 may be located on an outer surface of the first magnetic rotor 102. The inner magnets 106 may be magnetic field sources. For example, the inner magnets 106 may be permanent magnets. In another example, the inner magnets 106 may be electromagnets. The inner magnets 106 may be arranged to alternate polarity around the first magnetic rotor 102. For example, a first inner magnet 106A may be a first polarity, a second inner magnet 106B may be a second polarity, a third inner magnet 106C may be the first polarity, and a fourth inner magnet 106D may be the second polarity.

The tri-rotor generator 100 may include a coil rotor 108. In the first implementation of the tri-rotor generator 100, the coil rotor 108 may be, for example, a middle rotor. The coil rotor 108 may be made from, for example, plastic or metal (e.g., stamped metal pieces). The coil rotor 108 may be configured to rotate independently from the shaft 104. For example, the coil rotor 108 may include one or more bearings 110 such that the coil rotor 108 may rotate freely (e.g., independently) with respect to the shaft 104.

In the first implementation of the tri-rotor generator 100, the coil rotor 108 may include a first portion 108A of the coil rotor 108 and a second portion 108B of the coil rotor 108. The first portion 108A may include one or more coils 112. In an example, there may be eight coils 112. The coils 112 may be coils of conductive wire (e.g., copper) in which an electric current may be induced. For example, the coils 112 may be enclosed in the first portion 108A. The first portion 108A may at least partially surround the first magnetic rotor 102. The first portion 108A may surround the first magnetic rotor 102 such that the coils 112 intersect the magnetic field generated by the inner magnets 106.

The second portion 108B may extend beyond the first magnetic rotor 102 in an axial direction (e.g., along the shaft 104). The second portion 108B may include wires connected to the coils 112. The wires may electrically connect the coils 112 to conductive rings 109 around the second portion 108B. In an example, there may be eight coils 112 connected to four conductive rings 109 around the second portion 108B, that is, two conductive rings 109 may be electrically connected to four of the eight coils 112 and the other two conductive rings 109 may be connected to the other four of the eight coils 112.

The tri-rotor generator 100 may include a second magnetic rotor 114. In the first implementation of the tri-rotor generator 100, the second magnetic rotor 114 may be, for example, an outer rotor. The second magnetic rotor 114 may at least partially surround the first portion 108A of the coil rotor 108. In the first implementation of the tri-rotor generator 100, the first magnetic rotor 102, the coil rotor 108, and the second magnetic rotor 114 may be arranged in a radial direction extending perpendicular to an axial direction of the shaft 104.

The second magnetic rotor 114 may be made from metal, for example, steel. The second magnetic rotor 114 may be configured to rotate with the first magnetic rotor 102. The second magnetic rotor 114 may be rotationally connected to the shaft 104. Alternatively, the second magnetic rotor 114 may be rotationally connected to the first magnetic rotor 102. For example, the second magnetic rotor 114 may be connected to the shaft 104 using a shaft collar 115 and a side plate 116. The shaft collar 115 may be rotationally connected to the shaft 104. The side plate 116 may be connected to the second magnetic rotor 114 and the shaft collar 115. The second magnetic rotor 114 and the first magnetic rotor 102 may be configured to rotate synchronically and in a same direction.

The second magnetic rotor 114 may include one or more outer magnets 118. The outer magnets 118 may be located on an inner surface of the second magnetic rotor 114. The outer magnets 118 may be magnetic field sources. For example, the outer magnets 118 may be permanent magnets. In another example, the outer magnets 118 may be electromagnets. The second magnetic rotor 114 may surround the first portion 108A of the coil rotor 108 such that the coils 112 intersect the magnetic field generated by the outer magnets 118. The outer magnets 118 may be arranged to alternate polarity around the second magnetic rotor 114. For example, a first outer magnet 118A may be a first polarity, a second outer magnet 118B may be a second polarity, a third outer magnet 118C may be the first polarity, and a fourth outer magnet 118D may be the second polarity.

The first magnetic rotor 102 and the second magnetic rotor 114 may be configured to rotate synchronously and in a first direction, and the coil rotor 108 may be configured to rotate in a second direction opposite the first direction. For example, the first magnetic rotor 102 and the second magnetic rotor 114 may be configured to rotate in a clockwise direction, and the coil rotor 108 may be configured to rotate in a counterclockwise direction. The first magnetic rotor 102 and the second magnetic rotor 114 may be configured to rotate at a same speed. The coil rotor 108 may be configured to rotate at the same speed or at a different speed as the first magnetic rotor 102 and the second magnetic rotor 114, in an opposing direction. The coil rotor 108 may rotate freely (e.g., independently) with respect to the first magnetic rotor 102 and the second magnetic rotor 114. In the first implementation of the tri-rotor generator 100, the inner magnets 106 and the outer magnets 118 may generate a magnetic field (e.g., magnetic flux lines) in a direction that is substantially perpendicular to the shaft 104 (e.g., an axis of rotation).

In the first implementation of the tri-rotor generator 100, the coil rotor 108 may include teeth 120 wrapped around an outer surface of the coil rotor 108. The teeth 120 may be located between the first portion 108A and the second portion 108B. The teeth 120 may be connected to, for example, a timing pulley, a spur gear, a V-belt, or the like that is used to rotate the coil rotor 108 using a second motor. Accordingly, the first magnetic rotor 102 and the second magnetic rotor 114 may be driven in the first direction by the first motor, and the coil rotor 108 may be driven in the second direction by the second motor. In another example, the coil rotor 108 may be driven by (e.g., rotationally connected to) at least one gear rotationally connected to the shaft 104 or the first motor. The at least one gear may reverse a rotational direction of the shaft 104 as applied to the coil rotor 108 such that the shaft 104 rotates in the first direction and the coil rotor 108 rotates in the second direction. The tri-rotor generator 100 may be driven by a single motor, that is, the first magnetic rotor 102, the coil rotor 108, and the second magnetic rotor 114 may be rotationally connected to a motor.

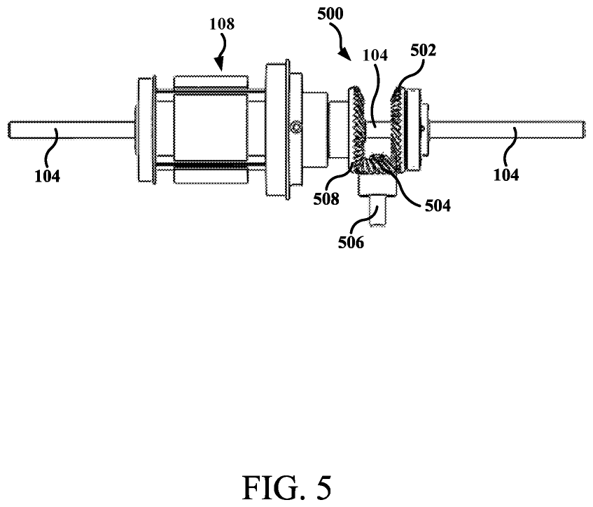

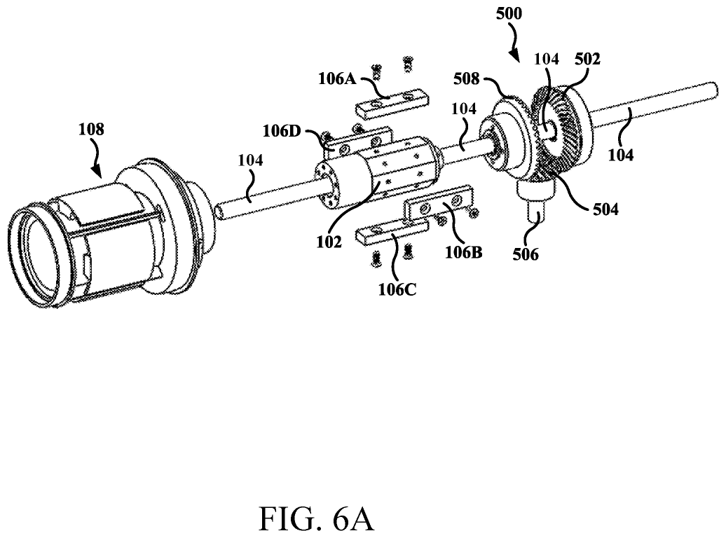

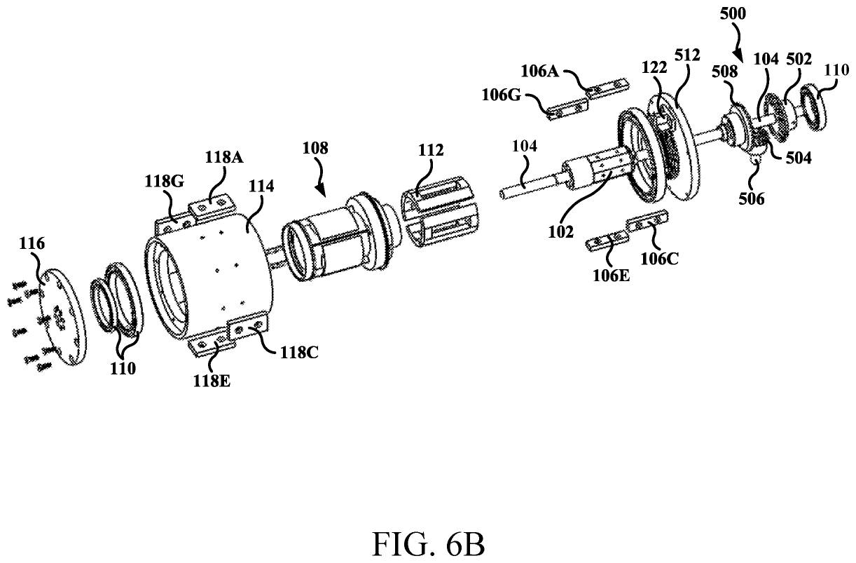

Referring to FIGS. 5, 6A, and 6B, the first magnetic rotor 102, the coil rotor 108, and the second magnetic rotor 114 may be rotationally connected to the motor through a gear box 500. The gear box 500 may be built into the tri-rotor generator 100 or may be an external gear box. The gear box 500 may allow the first magnetic rotor 102, the coil rotor 108, and the second magnetic rotor 114 to be rotationally connected to a single motor. The gear box 500 may be configured to reverse the direction of rotation of the coil rotor 108 relative to the first magnetic rotor 102 and the second magnetic rotor 114. For example, the shaft 104 may extend through the gear box 500 and be rotationally connected to the first magnetic rotor 102 and the second magnetic rotor 114. The coil rotor 108 may include one or more bearings 110 such that the coil rotor 108 may rotate freely (e.g., independently) with respect to the shaft 104, the first magnetic rotor 102, and/or the second magnetic rotor 114. The gear box 500 may include internal gearing that receives the rotational input from the shaft 104 and produces an opposing rotational output for the coil rotor 108. In an example, as shown in FIGS. 5, 6A, and 6B, the gear box 500 may be a spiral bevel gear. In other examples, the gear box 500 may be a planetary gear assembly, a worm gear system, a crossed helical gear set, a compound gear train configured to achieve the desired speed and direction of rotation, or the like. The gear box 500 may be designed to optimize torque distribution and phase synchronization.

The gear box 500 may include a drive gear 502, an idler gear 504, an idler shaft 506, and an output gear 508. The drive gear 502 may be mounted to the shaft 104 and configured to rotate with the shaft 104. The drive gear 502 may engage the idler gear 504, which may be mounted to the idler shaft 506. The idler gear 504 may reverse the direction of rotation and transfer torque to the output gear 508. The output gear 508 may be rotationally connected to the coil rotor 108. The drive gear 502, idler gear 504, and output gear 508 may be spiral bevel gears configured to transfer torque between intersecting shafts. The drive gear 502 may include one or more bearings 110 such that the drive gear 502 may rotate freely (e.g., independently) with respect to a housing of the tri-rotor generator 100. The gear box 500 may enable the coil rotor 108 to rotate in a direction opposite to the first magnetic rotor 102 and the second magnetic rotor 114 with one motor connected to the shaft 104.

The gear box 500 may be configured to selectively modify which of the first magnetic rotor 102, the coil rotor 108, and the second magnetic rotor 114 are rotationally connected to the motor. The gear box 500 may rotationally connect all or a subset of the first magnetic rotor 102, the coil rotor 108, and the second magnetic rotor 114 to the motor. For example, during periods of high (e.g., increased) load demand, the gear box 500 may operate in a full mode such that the first magnetic rotor 102, the coil rotor 108, and the second magnetic rotor 114 are all rotationally connected to the motor. In another example, during periods of low (e.g., reduced) load demand, the gear box 500 may operate in a reduced mode such that one or more of the first magnetic rotor 102, the coil rotor 108, and the second magnetic rotor 114 are not rotationally connected to the motor. The gear box 500 may be configured such that, during the reduced mode, only the first magnetic rotor 102, only the coil rotor 108, only the second magnetic rotor 114, or both the first magnetic rotor 102 and the second magnetic rotor 114 are rotationally connected to the motor. During the reduced mode, a rotor not rotationally connected to the motor may be stationary.

The gear box 500 may include multiple reduced modes corresponding to rotationally connecting different rotors to the motor. For example, a first reduced mode may correspond to only the coil rotor 108 rotationally connected to the motor, and a second reduced mode may correspond to both the first magnetic rotor 102 and the second magnetic rotor 114 (but not the coil rotor 108) rotationally connected to the motor. The gear box 500 may include a lever (e.g., a switch) configured to modify a number of rotors that are rotationally connected to the motor (e.g., switch between a full mode and any reduced modes).

Referring to FIGS. 1 to 6B, rotating the first magnetic rotor 102 and the second magnetic rotor 114 in the first direction and the coil rotor 108 in the second direction may cause the magnetic fields generated by the inner magnets 106 and the outer magnets 118 to sweep across the coils 112. The changing magnetic field induces current in the coils 112 that is transmitted by the wires to the conductive rings 109 around the second portion 108B of the coil rotor 108. A brush assembly 122 may be positioned to maintain electrical contact with the conductive rings 109. The brush assembly 122 may include one or more brushes 124 for collecting and transmitting the current to an external circuit or power management system. The brush assembly 122 may be secured using, for example, a brush plate 512. The brush plate 512 may be configured to remain stationary about the shaft 104 during rotation of the shaft 104. The brush plate 512 may maintain a position of the brush assembly 122 (and any brushes 124) with respect to the conductive rings 109.

The coils 112 may be separated into multiple phases of alternating current. For example, the coils 112 may be separated into two or more phases, each with an equal number of coils 112. The coils 112 may alternate phase around the first portion 108A. In an example where there are four coils 112, the coils 112 may be split into a first phase of two coils 112 and a second phase of two coils 112. For example, a first coil 112A and a third coil 112C may be associated with the first phase, and a second coil 112B and a fourth coil 112D may be associated with the second phase. In another example where there are eight coils 112, the coils 112 may be split into a first phase of four coils 112 and a second phase of four coils 112. For example, a first coil 112A, a third coil 112C, a fifth coil 112E, and a seventh coil 112G may be associated with the first phase, and a second coil 112B, a fourth coil 112D, a sixth coil 112F, and an eighth coil 112H may be associated with the second phase. A higher output frequency of the tri-rotor generator 100 may be obtained by adding additional coils 112, by adding additional magnets (e.g., the inner magnets 106 or the outer magnets 118), or by adding both additional coils 112 and additional magnets.

In an example where there are eight coils 112, each of the two phases may have two wires (i.e., four wires total). The two wires may be connected to the coils 112 associated with that phase, either in series or parallel (e.g., the coils 112 associated with that phase may terminate in a first wire and a second wire). For example, for maximum voltage, the two wires associated with the first phase are electrically connected to the first phase of four coils 112 in series, and the two wires associated with the second phase are electrically connected to the second phase of four coils 112 in series. In another example, for maximum current, the two wires associated with the first phase are electrically connected to the first phase of four coils 112 in parallel, and the two wires associated with the second phase are electrically connected to the second phase of four coils 112 in parallel. Each of the four wires may be connected to a conductive ring 109 (i.e., four conductive rings 109 total) on the outer surface of the second portion 108B. Each of the four conductive rings 109 may be electrically connected to a brush 124. Accordingly, each of the four wires may be electrically connected to a brush 124. In embodiments with three or more phases, the number of coils 112, wires, conductive rings 109, and brushes 124 may increase or decrease to accommodate the desired number of phases.

The coils 112 may be separated into one or more phases (e.g., single-phase, two-phase, three-phase). The coils 112 may be arranged in different configurations, for example, the coils 112 may be electrically arranged in a delta or Y (wye) configuration. The configuration of the coils 112 may increase or decrease a required number of components of the tri-rotor generator 100. The configuration of the coils 112 may increase or decrease the number of conductive rings 109. For example, in a three-phase delta configuration, three conductive rings 109 may be used, each conductive ring 109 corresponding to one terminal of a closed-loop winding arrangement. In another example, in a three-phase Y configuration, four conductive rings 109 may be used (e.g., one conductive ring 109 for each of the three phase outputs and one conductive ring 109 for the shared neutral connection).

The tri-rotor generator 100 may further include a clamp 126 surrounding the shaft 104. The clamp 126 may hold the first magnetic rotor 102, the coil rotor 108, and the second magnetic rotor 114 in place along the shaft 104.

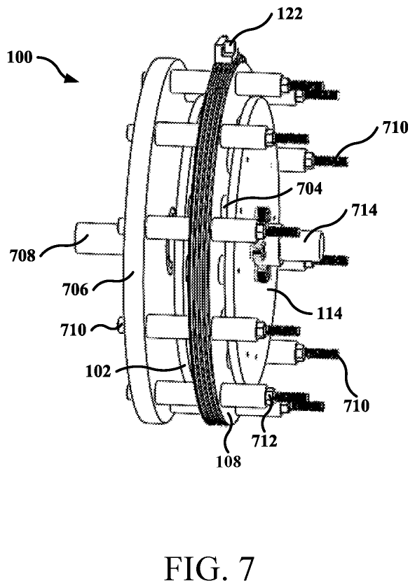

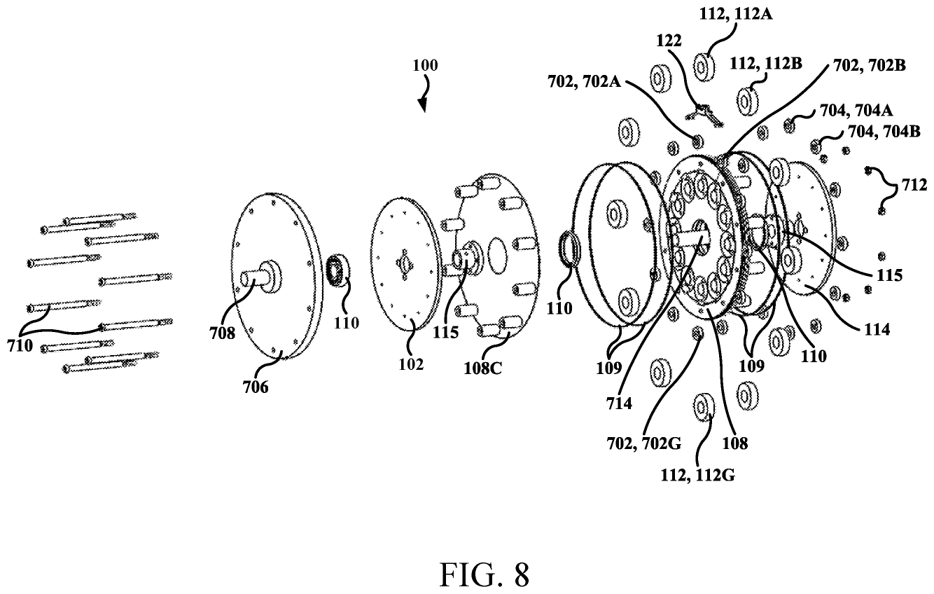

Referring to FIGS. 7 to 10, a second implementation (e.g., an axial configuration) of the tri-rotor generator 100 is shown. The tri-rotor generator 100 may include a case (e.g., a housing, container, cover, or the like) containing components of the tri-rotor generator 100. For ease of understanding, the case is omitted from FIGS. 7 to 10. In the second implementation of the tri-rotor generator 100, the coil rotor 108 may be, for example, a middle rotor. The coil rotor 108 may be made from, for example, plastic or metal (e.g., stamped metal pieces). The coil rotor 108 may include one or more coils 112. In an example, there may be twelve coils 112. The coils 112 may be coils of conductive wire (e.g., copper) in which an electric current may be induced. For example, the coils 112 may be enclosed in the coil rotor 108. The coil rotor 108 may be made from more than one piece. For example, a first piece of the coil rotor 108 may include recessed areas to contain the coils 112, and a second piece of the coil rotor 108 may secure the coils 112 in the recessed areas (e.g., by covering a surface of the first piece of the coil rotor 108 such that the coils 112 are contained between the first piece and the second piece of the coil rotor 108). The coil rotor 108 may include wires connected to the coils 112. The wires may electrically connect the coils 112 to conductive rings 109 around the coil rotor 108. In an example, there may be twelve coils 112 connected to four conductive rings 109 around the second portion 108B, that is, two conductive rings 109 may be electrically connected to six of the twelve coils 112 and the other two conductive rings 109 may be connected to the other six of the twelve coils 112.

In the second implementation of the tri-rotor generator 100, the first magnetic rotor 102 may be, for example, a first side rotor. The first magnetic rotor 102 may be made from metal, for example, steel. The first magnetic rotor 102 may include one or more first side magnets 702. The first side magnets 702 may be located on a side surface of the first magnetic rotor 102. The first side magnets 702 may be magnetic field sources. For example, the first side magnets 702 may be permanent magnets. In another example, the first side magnets 702 may be electromagnets. The first side magnets 702 may be arranged to alternate polarity around the first magnetic rotor 102. For example, a first first side magnet 702A may be a first polarity, a second first side magnet 702B may be a second polarity, a third first side magnet 702C may be the first polarity, and a fourth first side magnet 702D may be the second polarity.

In the second implementation of the tri-rotor generator 100, the second magnetic rotor 114 may be, for example, a second side rotor. The second magnetic rotor 114 may be made from metal, for example, steel. The second magnetic rotor 114 and the first magnetic rotor 102 may be configured to rotate in a same direction. In an example, the second magnetic rotor 114 and the first magnetic rotor 102 may be configured to rotate synchronously. The second magnetic rotor 114 may include one or more second side magnets 704. The second side magnets 704 may be located on a side surface of the second magnetic rotor 114. The second side magnets 704 may be magnetic field sources. For example, the second side magnets 704 may be permanent magnets. In another example, the second side magnets 704 may be electromagnets. The second side magnets 704 may be arranged to alternate polarity around the second magnetic rotor 114. For example, a first second side magnet 704A may be a first polarity, a second second side magnet 704B may be a second polarity, a third second side magnet 704C may be the first polarity, and a fourth second side magnet 704D may be the second polarity. In the second implementation of the tri-rotor generator 100, the first side magnets 702 and the second side magnets 704 may generate a magnetic field (e.g., magnetic flux lines) in a direction that is substantially parallel to the axis of rotation.

The coil rotor 108 may be disposed between the first magnetic rotor 102 and the second magnetic rotor 114. The coil rotor 108 may be positioned such that it is located within a magnetic field generated by the first side magnets 702 and the second side magnets 704. The first magnetic rotor 102, the coil rotor 108, and the second magnetic rotor 114 may be arranged sequentially along a common axis (e.g., a central rotational axis). The first magnetic rotor 102 may be positioned such that the first side magnets 702 are located adjacent to one side of the coil rotor 108. The second magnetic rotor 114 may be positioned such that the second side magnets 704 are located adjacent to the opposite side of the coil rotor 108. This positioning allows the opposing magnetic fields from the first magnetic rotor 102 and the second magnetic rotor 114 to interact across the coils 112 of the coil rotor 108. The coil rotor 108 may include one or more bearings 110 such that the coil rotor 108 may rotate freely (e.g., independently) with respect to the first magnetic rotor 102 and/or the second magnetic rotor 114.

The second implementation of the tri-rotor generator 100 may include an interface disk 706. The interface disk 706 may include or support a first shaft 708 and may be mechanically connected to the coil rotor 108. The interface disk 706 may at least partially cover or enclose the first magnetic rotor 102. The first magnetic rotor 102 may be positioned (e.g., disposed) between the interface disk 706 and the coil rotor 108. The interface disk 706 may be secured to the coil rotor 108 using fasteners, for example, bolts 710 and nuts 712. The coil rotor 108 may further include a coil rotor plate 108C. The coil rotor plate 108C may be removable. The coil rotor plate 108C may be removed to allow for placement or replacement of the coils 112 within the coil rotor 108. The coil rotor plate 108C may be attached to the coil rotor 108 using the bolts 710.

The second implementation of the tri-rotor generator 100 may include a second shaft 714. The second shaft 714 may be rotationally connected to the first magnetic rotor 102 and the second magnetic rotor 114. The first magnetic rotor 102 and the second magnetic rotor 114 may each be rotationally connected to the second shaft 714 using a shaft collar 115 or other mechanical coupling. The first shaft 708 may be rotationally connected to the coil rotor 108. The first shaft 708 may be an input shaft driven by, for example, a wind turbine or vehicle engine. Rotating the first shaft 708 and the second shaft 714 may enable counter-rotation of the first magnetic rotor 102 and the second magnetic rotor 114 with respect to the coil rotor 108. For example, a first motor may be connected to the first shaft 708 and may be configured to rotate the coil rotor 108 in a first direction, while a second motor may be connected to the second shaft 714 and configured to rotate the first magnetic rotor 102 and the second magnetic rotor 114 in a second, opposite direction. The first shaft 708 and the second shaft 714 may be supported by bearings 110 or bushings to reduce friction and facilitate stable rotation. The first motor and the second motor may be independently controlled based on desired rotational speeds, phase relationships, or power outputs.

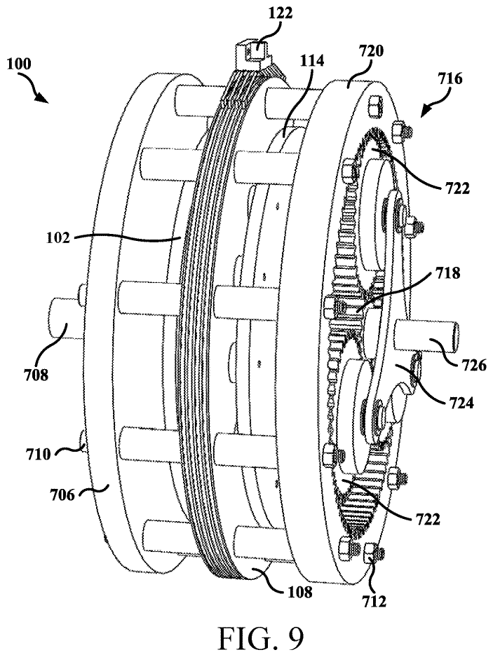

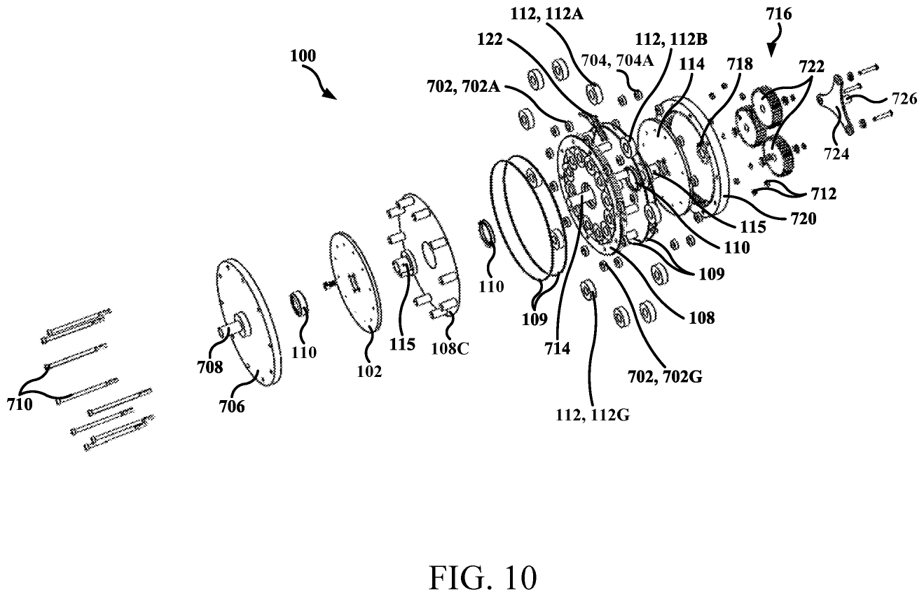

The first magnetic rotor 102, the coil rotor 108, and the second magnetic rotor 114 may be rotationally connected to a gear box 500. The gear box 500 may be built into the tri-rotor generator 100 or may be an external gear box. The gear box 500 may allow the first magnetic rotor 102, the coil rotor 108, and the second magnetic rotor 114 to be rotationally connected to a single motor. The gear box 500 may be configured to reverse the direction of rotation of the coil rotor 108 relative to the first magnetic rotor 102 and the second magnetic rotor 114. For example, the gear box 500 may include internal gearing that receives the rotational input from the first shaft 708 and produces an opposing rotational output for the first magnetic rotor 102 and the second magnetic rotor 114. In an example, as shown in FIGS. 9 and 10, the gear box 500 may be a planetary gear assembly 716. In other examples, the gear box 500 may be a spiral bevel gear, a worm gear system, a crossed helical gear set, a compound gear train configured to achieve the desired speed and direction of rotation, or the like. The gear box 500 may be designed to optimize torque distribution and phase synchronization.

The gear box 500 may be configured to selectively modify which of the first magnetic rotor 102, the coil rotor 108, and the second magnetic rotor 114 are rotationally connected to the motor. The gear box 500 may rotationally connect all or a subset of the first magnetic rotor 102, the coil rotor 108, and the second magnetic rotor 114 to the motor. For example, during periods of high (e.g., increased) load demand, the gear box 500 may operate in a full mode such that the first magnetic rotor 102, the coil rotor 108, and the second magnetic rotor 114 are all rotationally connected to the motor. In another example, during periods of low (e.g., reduced) load demand, the gear box 500 may operate in a reduced mode such that one or more of the first magnetic rotor 102, the coil rotor 108, and the second magnetic rotor 114 are not rotationally connected to the motor. The gear box 500 may be configured such that, during the reduced mode, only the first magnetic rotor 102, only the coil rotor 108, only the second magnetic rotor 114, or both the first magnetic rotor 102 and the second magnetic rotor 114 are rotationally connected to the motor. During the reduced mode, a rotor not rotationally connected to the motor may be stationary.

The gear box 500 may include multiple reduced modes corresponding to rotationally connecting different rotors to the motor. For example, a first reduced mode may correspond to only the coil rotor 108 rotationally connected to the motor, and a second reduced mode may correspond to both the first magnetic rotor 102 and the second magnetic rotor 114 (but not the coil rotor 108) rotationally connected to the motor. The gear box 500 may include a lever (e.g., a switch) configured to modify a number of rotors that are rotationally connected to the motor (e.g., switch between a full mode and any reduced modes).

Referring to FIGS. 9 and 10, the second implementation of the tri-rotor generator 100 including the planetary gear assembly 716 is shown. The planetary gear assembly 716 may be located along the common axis of the tri-rotor generator 100. The planetary gear assembly 716 may be positioned on a side of the tri-rotor generator 100 and may be mechanically integrated with the first magnetic rotor 102, the coil rotor 108, and the second magnetic rotor 114. The planetary gear assembly 716 may comprise a sun gear 718, a ring gear 720, and one or more planetary gears 722 (e.g., three planetary gears). The second shaft 714 may be rotationally connected to the sun gear 718. The planetary gear assembly 716 may further include a planet carrier 724 connected to the planetary gears 722. The planet carrier 724 may include a third shaft 726. The planetary gear assembly 716 may operate by transferring torque between the ring gear 720 and the sun gear 718 through the planetary gears 722, which are supported by the planet carrier 724. The planetary gear assembly 716 may enable counter-rotation of the ring gear 720 and the sun gear 718.

The ring gear 720 may be rotationally connected to the first shaft 708 and the coil rotor 108. For example, the ring gear 720 may be secured to the coil rotor 108 using the bolts 710. Rotation of the ring gear 720 may enable counter-rotation of the coil rotor 108 with respect to the first magnetic rotor 102 and the second magnetic rotor 114. In an example, the ring gear 720 may be rotated by rotating the first shaft 708. In other examples, the ring gear 720 may be rotated using a timing pulley, a spur gear, a V-belt, or the like. Rotating the ring gear 720 in a first direction may cause the coil rotor 108 to rotate in the first direction and the sun gear 718 to rotate in a second, opposite direction. Rotating the sun gear 718 in the second direction may cause the second shaft 714, the first magnetic rotor 102, and the second magnetic rotor 114 to rotate in the second direction. Accordingly, using the planetary gear assembly 716, a single motor may be used to rotate the first magnetic rotor 102, the second magnetic rotor 114, and the coil rotor 108.

The sun gear 718 and the ring gear 720 may be configured to rotate in opposite directions. In some examples, the first magnetic rotor 102 and the second magnetic rotor 114 may be rotationally connected to the sun gear 718, and the coil rotor 108 may be rotationally connected to the ring gear 720. Alternatively, in other examples, the first magnetic rotor 102 and the second magnetic rotor 114 may be rotationally connected to the ring gear 720, and the coil rotor 108 may be rotationally connected to the sun gear 718.

In an example (shown in FIGS. 9 and 10), the coil rotor 108 may be rotationally connected to the ring gear 720, and the first magnetic rotor 102 and the second magnetic rotor 114 may be rotationally connected to the sun gear 718. The first shaft 708 may be rotationally connected to the interface disk 706 (e.g., to the coil rotor 108) and used to drive the ring gear 720. The first shaft 708 may be configured to rotate (e.g., drive) the coil rotor 108 and the ring gear 720 (e.g., in a first direction). The first shaft 708 may be connected to a rotation source, for example, blades of a wind turbine. The second shaft 714 may be rotationally connected to the first magnetic rotor 102 and the second magnetic rotor 114. The third shaft 726 may be connected to the planet carrier 724. Rotation of the first shaft causes the ring gear 720 and the coil rotor 108 to rotate in a first direction, which causes the sun gear 718 to rotate in a second direction opposite the first direction. Rotation of the sun gear 718 in the second direction causes the first magnetic rotor 102 and the second magnetic rotor 114 to rotate in the second direction. In some examples, the first shaft 708 may be omitted, and the ring gear 720 may be rotationally connected to a rotation source through, for example, pulleys, gears, or the like.

The planetary gear assembly 716 may operate as a continuously variable transmission (CVT). For example, the planetary gear assembly 716 may function as an electronically-controlled continuously variable transmission (E-CVT). The third shaft 726 may be used to drive the planet carrier 724. The E-CVT may allow dynamic control of the rotational relationship between the sun gear 718 and the ring gear 720 by adjusting the rotational input to the planet carrier 724. By modulating the speed of the third shaft 726, the rotational speed of the coil rotor 108 relative to the first magnetic rotor 102 and the second magnetic rotor 114 may be controlled. Controlling the rotational speed of the planet carrier 724 may enable the tri-rotor generator 100 to maintain a consistent relative rotational speed between the coil rotor 108 and the magnetic rotors (e.g., the first magnetic rotor 102 and the second magnetic rotor 114), thereby producing a stable electrical output frequency. The speed of the third shaft 726 may be controlled based on an input speed (e.g., the speed of the first shaft 708), i.e., a motor rotationally connected to the third shaft 726 may be configured to rotate the third shaft 726 in response to changes in rotation of the first shaft 708. The E-CVT may allow the tri-rotor generator 100 to generate electricity at a standard frequency (e.g., 50 Hz, 60 Hz, or the like) regardless of variations in mechanical input speed (e.g., rotation of the first shaft 708). The E-CVT may facilitate connecting the tri-rotor generator 100 directly to an electrical grid or for applications that require frequency-stable power output.

Rotating the first magnetic rotor 102 and the second magnetic rotor 114 in a first direction and the coil rotor 108 in a second, opposite direction may cause the magnetic fields generated by the first side magnets 702 and the second side magnets 704 to sweep axially across the coils 112 of the coil rotor 108. The changing magnetic field may induce an electric current in the coils 112. The induced current may be transmitted by electrical wires to conductive rings 109 located around the coil rotor 108. A brush assembly 122 may be positioned to maintain electrical contact with the conductive rings 109. The brush assembly 122 may include at least one brush 124 for collecting and transmitting the current to an external circuit or power management system.

The coils 112 may be separated into multiple phases of alternating current. For example, the coils 112 may be separated into two or more phases, each with an equal number of coils 112. In an example where there are twelve coils 112, the coils 112 may be split into a first phase of six coils 112 and a second phase of six coils 112. The coils 112 may alternate phase around the coil rotor 108. For example, a first coil 112A, a third coil 112C, a fifth coil 112E, a seventh coil 112G, a ninth coil 112I, and an eleventh coil 112K may be associated with the first phase, and a second coil 112B, a fourth coil 112D, a sixth coil 112F, an eighth coil 112H, a tenth coil 112J, and a twelfth coil 112L may be associated with the second phase. A higher output frequency of the tri-rotor generator 100 may be obtained by adding additional coils 112, by adding additional magnets (e.g., the first side magnets 702 or the second side magnets 704), or by adding both additional coils 112 and additional magnets.

In another example where there are twelve coils 112, the coils 112 may be separated into three phases. Each of the three phases may include four coils 112. The coils 112 may alternate by phase around the coil rotor 108. For example, a first coil 112A, a fourth coil 112D, a seventh coil 112G, and a tenth coil 112J may be associated with the first phase, a second coil 112B, a fifth coil 112E, an eighth coil 112H, and an eleventh coil 112K may be associated with the second phase, and a third coil 112C, a sixth coil 112F, a ninth coil 112I, and a twelfth coil 112L may be associated with the third phase.

The coils 112 may be separated into one or more phases (e.g., single-phase, two-phase, three-phase). The coils 112 may be arranged in different configurations, for example, the coils 112 may be electrically arranged in a delta or Y (wye) configuration. The configuration of the coils 112 may increase or decrease a required number of components of the tri-rotor generator 100. The configuration of the coils 112 may increase or decrease the number of conductive rings 109. For example, in a three-phase delta configuration, three conductive rings 109 may be used, each conductive ring 109 corresponding to one terminal of a closed-loop winding arrangement. In another example, in a three-phase Y configuration, four conductive rings 109 may be used (e.g., one conductive ring 109 for each of the three phase outputs and one conductive ring 109 for the shared neutral connection).

Each phase may be associated with two wires (i.e., four wires total in a two-phase configuration, or six wires total in a three-phase configuration). The wires may be electrically connected to conductive rings 109 around the coil rotor 108. Each wire may be electrically connected to a respective conductive ring 109. Each conductive ring 109 may be electrically connected to a respective brush 124. Accordingly, each of the wires may be electrically connected to a brush 124. In embodiments with a different number of phases, the number of coils 112, wires, conductive rings 109, and brushes 124 may increase or decrease to accommodate the desired number of phases.

In the second implementation of the tri-rotor generator 100, the power output may be increased by adding one or more additional magnetic rotors and one or more additional coil rotors. The additional rotors may be added along the axis of rotation. In an example where the first magnetic rotor 102 and the second magnetic rotor 114 are rotationally connected to the second shaft 714, any additional magnetic rotors may be rotationally connected to the second shaft 714. In an example where the coil rotor 108 is rotationally connected to the first shaft 708 (e.g., through the interface disk 706), any additional coil rotors may be rotationally connected to the first shaft 708. A magnetic rotor between two coil rotors may be configured to have magnets on both sides. The additional rotors may be added such that every coil rotor has a magnetic rotor on each side. For example, a generator containing five rotors may include a first magnetic rotor, a second magnetic rotor, a third magnetic rotor, a first coil rotor disposed between the first magnetic rotor and the second magnetic rotor, and a second coil rotor disposed between the second magnetic rotor and the third magnetic rotor. The second magnetic rotor may include magnets adjacent to the first coil rotor and magnets adjacent to the second coil rotor. In another example, a generator containing six rotors may include a first magnetic rotor, a second magnetic rotor, a third magnetic rotor, a fourth magnetic rotor, a first coil rotor disposed between the first magnetic rotor and the second magnetic rotor, and a second coil rotor disposed between the third magnetic rotor and the fourth magnetic rotor. Any number of additional magnetic rotors and additional coil rotors may be added to increase the power output of the generator without significant increases in a diameter of the generator.

The tri-rotor generator 100 may be employed in a variety of applications. For example, the tri-rotor generator 100 may be used as a vehicle alternator (e.g., in automobiles, trucks, or buses) or as an aircraft alternator (e.g., in planes, helicopters, or drones). The tri-rotor generator 100 may be implemented in systems using single-phase or multi-phase configurations. In an example, the tri-rotor generator 100 may be used in AC to DC power conversion systems (e.g., for battery charging or onboard power electronics). In another example, the tri-rotor generator may be incorporated into water energy systems (e.g., water wheels), wind energy systems (e.g., wind turbines), or the like, including wind turbines with single blades, dual blades, or other blade configurations.

The first implementation of the tri-rotor generator 100 (e.g., the radial configuration) may be particularly suitable for high-speed applications, such as use with internal combustion engines, where low to mid-range power output is desired. For example, the radial configuration may be well-suited for vehicle or aircraft alternators that operate at relatively high shaft speeds. The radial configuration may support single-phase or multi-phase operation and may be adapted for either AC or AC-to-DC output.

The second implementation of the tri-rotor generator (e.g., the axial configuration) may be particularly suited for low-speed applications where higher power output is required, such as wind energy harvesting. For example, the axial configuration may be used in horizontal or vertical axis wind turbines with one or more blades, and may be configured for one or more phase (e.g., single-phase, two-phase, three-phase, or the like) AC output. In some implementations, the axial configuration may also be adapted for use in grid-tied systems, where constant frequency output is required for direct electrical grid integration.

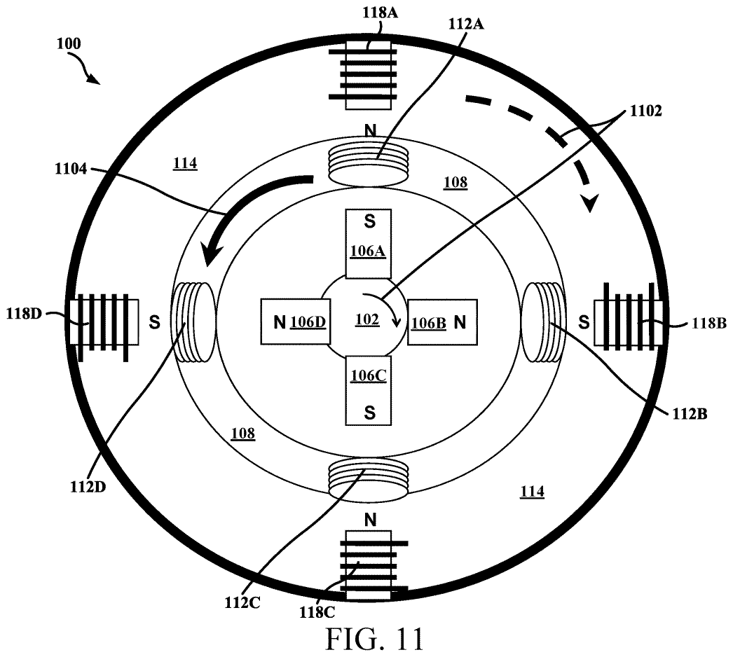

Referring to FIG. 11, a third implementation of the tri-rotor generator 100 may include electromagnets. The third implementation of the tri-rotor generator 100 may be a doubly fed tri-rotor generator (DFTRG). The third implementation of the tri-rotor generator 100 may include a first magnetic field assembly (e.g., the first magnetic rotor 102), a coil assembly (e.g., the coil rotor 108), and a second magnetic field assembly (e.g., the second magnetic rotor 114). The third implementation of the tri-rotor generator 100 may be arranged in a radial configuration (e.g., similar to the first implementation of the tri-rotor generator 100) or an axial configuration (e.g., similar to the second implementation of the tri-rotor generator 100).

The first magnetic rotor 102 may contain electromagnets, the second magnetic rotor 114 may contain electromagnets, or both. Electromagnets may be used to produce a rotating magnetic field without physical rotation of permanent magnets. That is, electromagnets may simulate rotation of the first magnetic rotor 102 and/or the second magnetic rotor 114 while the rotor remains stationary. In some examples, a stationary rotor may be mechanically fixed relative to the housing.

Electromagnets may be used to control the amplitude of the voltage induced in the coils 112 of the coil rotor 108. Increasing the current applied to the electromagnets may increase the magnetic field strength, and correspondingly increase the amplitude of the voltage induced in the coils 112. The frequency and phase of the voltage induced in the coils 112 of the coil rotor 108 may be controlled. The frequency and phase may be controlled based on physical rotation of permanent magnets, physical rotation of the coils 112, and/or simulated rotation of electromagnets.

Electrical power supplied to the electromagnets may contribute to the magnetic field energy surrounding the coil rotor 108, such that the tri-rotor generator 100 may be both mechanically and electrically excited. The tri-rotor generator 100 may facilitate control of the amplitude, frequency, and phase of the voltage induced in the coils 112. An output of the tri-rotor generator 100 may be connected directly to applications that require controlled amplitude, frequency, and/or phase. For example, the tri-rotor generator 100 may be connected directly to an electrical grid without the need for a grid-tie inverter.

FIG. 11 is a cross-section of the tri-rotor generator 100 including electromagnets. A radial configuration of the tri-rotor generator 100 is shown in FIG. 11, however, an axial configuration may be used. The first magnetic rotor 102 includes one or more inner magnets 106 and the second magnetic rotor 114 includes one or more outer magnets 118. In a first example, the inner magnets 106 may be permanent magnets and the outer magnets 118 may be electromagnets. The first magnetic rotor 102 may physically rotate in a first direction 1102 (e.g., clockwise), the coil rotor 108 may physically rotate in a second direction 1104 (e.g., counterclockwise), and the second magnetic rotor 114 may simulate rotation in the first direction 1102 (e.g., clockwise). Alternatively, the coil rotor 108 may be fixed.

The first magnetic rotor 102 may be rotationally connected to a shaft. The first magnetic rotor 102 may be rotated by the shaft, that is, a rotational force applied to the shaft may drive the first magnetic rotor 102. Rotational force may be applied to the shaft using, for example, a first motor, a wind turbine, a vehicle engine, or another rotation source. The first magnetic rotor 102 includes one or more inner magnets 106. For example, in FIG. 11, four inner magnets 106 are shown. The inner magnets 106 may be arranged to alternate polarity around the first magnetic rotor 102. For example, the first inner magnet 106A may be a first polarity (e.g., south), the second inner magnet 106B may be a second polarity (e.g., north), the third inner magnet 106C may be the first polarity (e.g., south), and the fourth inner magnet 106D may be the second polarity (e.g., north).

The coil rotor 108 may be configured to rotate in a direction opposite the direction of rotation of the first magnetic rotor 102 (e.g., counterclockwise). The coil rotor 108 may rotate at a same speed as the first magnetic rotor 102, in an opposing direction. The coil rotor 108 may rotate freely (e.g., independently) with respect to the first magnetic rotor 102 and the second magnetic rotor 114. The coil rotor 108 may be rotated using, for example, a second shaft, a second motor, a gear box (e.g., the gear box 500), a planetary gear assembly (e.g., the planetary gear assembly 716), or the like. The coil rotor 108 includes one or more coils 112. For example, in FIG. 11, four coils 112 are shown (e.g., the first coil 112A, the second coil 112B, the third coil 112C, and the fourth coil 112D).

The second magnetic rotor 114 may be physically stationary and include electromagnets as the outer magnets 118. The electromagnets (e.g., the outer magnets 118) may simulate rotation of the second magnetic rotor 114 in the same direction as the physical rotation of the first magnetic rotor 102 (e.g., the first direction 1102). The rotating magnetic field to be created by the electromagnets may be derived electronically based on the first magnetic rotor 102 and/or the coil rotor 108. In FIG. 11, four outer magnets 118 are shown as an example, but other configurations and/or quantities of electromagnets may be used. The electromagnets may be injected (e.g., supplied, fed) with time-varying current (e.g., sinusoidal, cosinusoidal, square wave, or the like). Each electromagnet may be injected with a different phase of current based on a position of the electromagnet around the second magnetic rotor 114. In an example, electromagnets positioned across from one another (e.g., 180° apart around the second magnetic rotor 114) may be injected with the same phase of current (e.g., receive current from the same source). Injecting the electromagnets with a different phase of current may allow the electromagnets to alternate polarity around the second magnetic rotor 114. A first current may be injected into the first outer magnet 118A and the third outer magnet 118C, and a second current may be injected into the second outer magnet 118B and the fourth outer magnet 118D. The first current and the second current may be the same frequency but 180° out of phase. The frequency of the first current and the second current may be the same as the frequency of the rotating magnetic field generated by the first magnetic rotor 102.

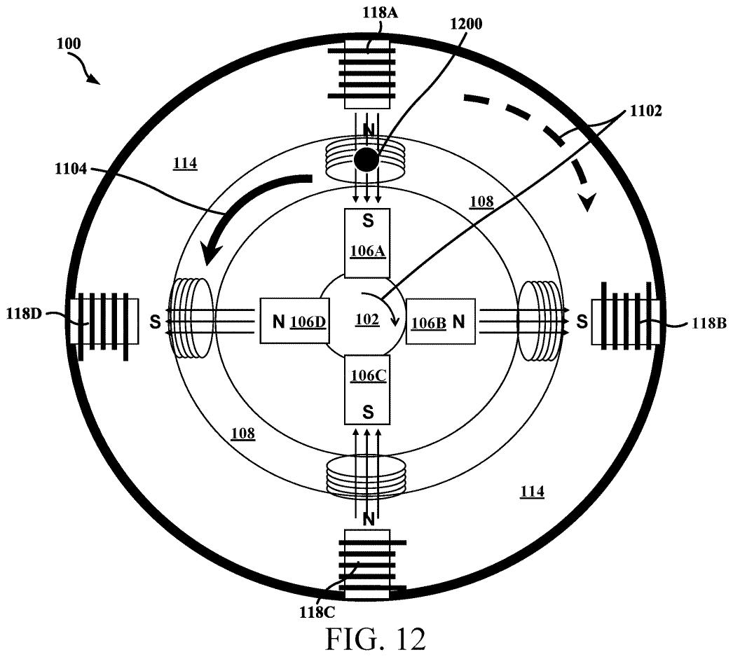

Referring to FIGS. 12-14, the magnetic field produced by the tri-rotor generator 100 will be described with respect to a point 1200. The point 1200 may be a point in space and may be located within the coil rotor 108. At a first time (e.g., t=0), the point 1200 may be located within the coil rotor 108 between the first outer magnet 118A and the first inner magnet 106A. The point 1200 may remain proximate to the first outer magnet 118A as the coil rotor 108 and the first magnetic rotor 102 rotate.

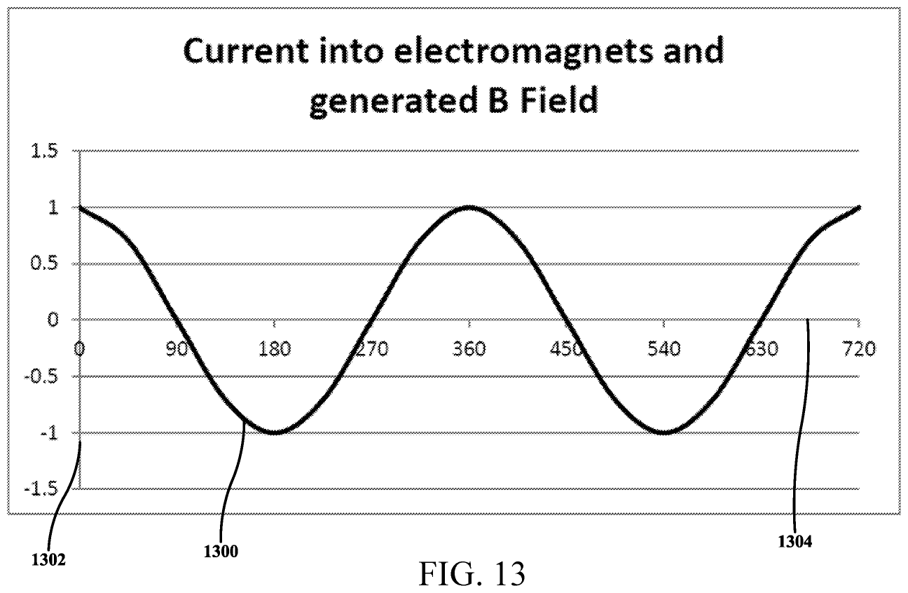

A current waveform 1300 is shown in FIG. 13. The current waveform 1300 may be injected (e.g., supplied, fed) into one or more of the electromagnets. The current waveform 1300 may be, for example, a time-varying current (e.g., sinusoidal, cosinusoidal, square wave, or the like). The y-axis 1302 represents a normalized magnetic field strength (B-field) produced by the electromagnets, and the x-axis 1304 represents an angular position of the first magnetic rotor 102. Accordingly, the current waveform 1300 illustrates how the magnetic field generated by the electromagnets varies as a function of angular position of the first magnetic rotor 102. The current waveform 1300 may represent one mechanical rotation of the coil rotor 108 and the first magnetic rotor 102. That is, the current waveform 1300 may represent two complete wavelengths. The example in FIG. 12 contains four outer magnets 118 (e.g., the electromagnets) and four inner magnets 106, creating a two-pole system with two complete electrical cycles for each mechanical revolution (e.g., rotation of the coil rotor 108 and the first magnetic rotor 102). Other configurations and/or quantities of electromagnets and permanent magnets may be used.

The current waveform 1300 may contribute to an electric field at the point 1200. The current waveform 1300 may be injected into the first outer magnet 118A. At time t=0, the current waveform 1300 may produce a north pole at an end of the first outer magnet 118A proximate to point 1200. The current waveform 1300 injected into the first outer magnet 118A may have a normalized magnetic field strength (e.g., B-field strength) of 1 at the first time (e.g., t=0). As the first magnetic rotor 102 rotates (e.g., clockwise) the magnetic field strength at the point 1200 will correspond to the current waveform 1300. Minimum strength of the magnetic field at the point 1200 with respect to the first magnetic rotor 102 may occur at 45 degrees, 135 degrees, 225 degrees, 315 degrees, and the like. Maximum strength of the magnetic field at the point 1200 with respect to the first magnetic rotor 102 may occur at 0 degrees, 90 degrees, 180 degrees, 270 degrees, 360 degrees, and the like.

The current waveform 1300 may have a frequency based on the rotation of the first magnetic rotor 102 (e.g., the rotation of the inner magnets 106). The magnetic field generated by the electromagnets (e.g., the outer magnets 118) may follow the magnetic field generated by the permanent magnets (e.g., the inner magnets 106). The magnetic fields are vectors that may combine, for example, at the point 1200. The magnitude of the current in the coils 112 may be proportional to the current applied to the electromagnets (e.g., the outer magnets 118) and the magnetic field strength of the permanent magnets (e.g., the inner magnets 106). For example, the magnetic field strength at the point 1200 may be equal to the sum of the magnetic field strength of the magnetic field generated by the electromagnets (e.g., the outer magnets 118) at the point 1200 and the magnetic field strength of the magnetic field generated by the permanent magnets (e.g., the inner magnets 106) at the point 1200. For example, the magnetic field at the point 1200 may be expressed as Bₐ=B₁+B₂, where B₁ is the magnetic field produced by the electromagnets and B₂ is the magnetic field produced by the permanent magnets.

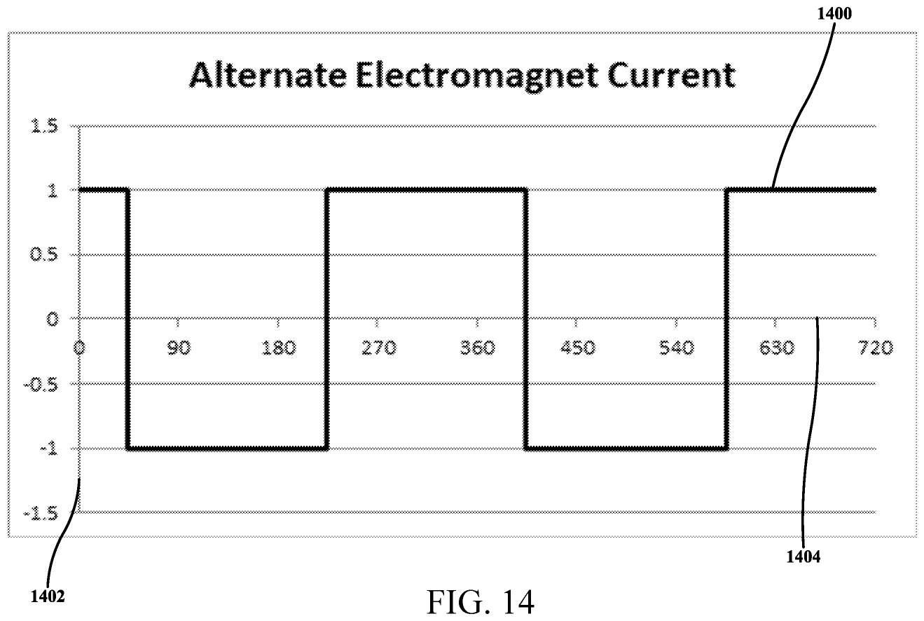

An example of a current digitized waveform 1400 is shown in FIG. 14. The current digitized waveform 1400 may be injected (e.g., supplied, fed) into the electromagnets (e.g., the outer magnets 118). The y-axis 1402 represents a normalized magnetic field strength (B-field) produced by the electromagnets, and the x-axis 1404 represents an angular position of the first magnetic rotor 102. Accordingly, the current digitized waveform 1400 illustrates how the magnetic field generated by the electromagnets varies as a function of angular position of the first magnetic rotor 102. The current digitized waveform 1400 represents a time-varying current in a digitized form, such as a square wave or other discretized waveform, in contrast to the analog waveform (e.g., sinusoidal or cosinusoidal) described with respect to FIG. 13. The current digitized waveform 1400 may be used as an alternative to analog excitation of the electromagnets. Supplying the current digitized waveform 1400 to the electromagnets may produce a corresponding magnetic field that varies in discrete steps with respect to angular position, while still generating a rotating magnetic field relative to the coil rotor 108. Use of a digitized waveform may simplify control circuitry or improve compatibility with digital control systems.

The tri-rotor generator 100 may include control electronics configured to control the output signal of the tri-rotor generator 100. The control electronics may provide feedback of the position of the coil rotor 108 and/or the first magnetic rotor 102. The position of the coil rotor 108 and/or the first magnetic rotor 102 may be used to control the current injected into the electromagnets (e.g., the outer magnets 118). The control electronics may adjust the current phase in real time. The control electronics may be configured to synchronize the rotating magnetic field to the mechanical position of the coil rotor 108. In some examples, the control electronics may be used to facilitate phase-locking of the output of the tri-rotor generator to an external reference.

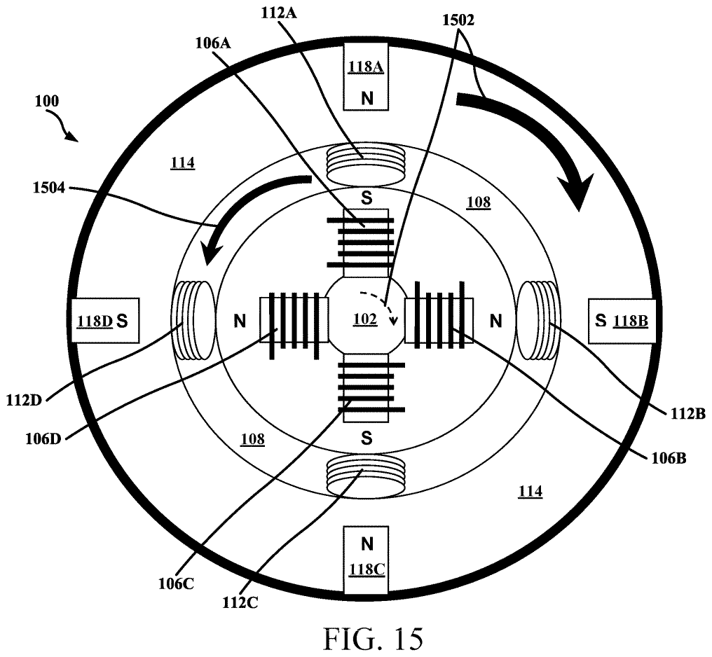

FIG. 15 is a cross-section of the tri-rotor generator 100 including electromagnets. A radial configuration of the tri-rotor generator 100 is shown in FIG. 15, however, an axial configuration may be used. The first magnetic rotor 102 includes one or more inner magnets 106 and the second magnetic rotor 114 includes one or more outer magnets 118. In a second example, the inner magnets 106 may be electromagnets and the outer magnets 118 may be permanent magnets. The first magnetic rotor 102 may simulate rotation in a first direction 1502 (e.g., clockwise), the coil rotor 108 may physically rotate in a second direction 1504 (e.g., counterclockwise), and the second magnetic rotor 114 may physically rotate in the first direction 1502 (e.g., clockwise). Alternatively, the coil rotor 108 may be fixed.

The first magnetic rotor 102 may be physically stationary and include electromagnets as the inner magnets 106. The electromagnets (e.g., the inner magnets 106) may simulate rotation of the first magnetic rotor 102 in the same direction as the physical rotation of the second magnetic rotor 114 (e.g., clockwise). The rotating magnetic field to be created by the electromagnets may be derived electronically based on the second magnetic rotor 114 and the coil rotor 108. In FIG. 15, four inner magnets 106 are shown as an example, but other configurations and/or quantities of electromagnets may be used. The electromagnets may be injected (e.g., supplied, fed) with time-varying current (e.g., sinusoidal, cosinusoidal, square wave, or the like). For example, the electromagnets may be injected with the current waveform 1300, a phase-shifted cosinusoidal current, the current digitized waveform 1400, a phase-shifted current digitized waveform, or the like. Each electromagnet may be injected with a different phase of current based on a position of the electromagnet around the first magnetic rotor 102. In an example, electromagnets positioned opposite one another (e.g., 180° apart around the first magnetic rotor 102) may be injected with the same phase of current (e.g., receive current from the same source). Injecting the electromagnets with a different phase of current may allow the electromagnets to alternate polarity around the first magnetic rotor 102. In the example shown in FIG. 15, a first current may be injected into the first inner magnet 106A and the third inner magnet 106C, and a second current may be injected into the second inner magnet 106B and the fourth inner magnet 106D. The first current and the second current may be the same frequency but 180° out of phase. The frequency of the first current and the second current may be the same as the frequency of the rotating magnetic field generated by the second magnetic rotor 114.

The coil rotor 108 may be configured to rotate in a direction opposite the direction of rotation of the second magnetic rotor 114 (e.g., counterclockwise). The coil rotor 108 may rotate at a same speed as the second magnetic rotor 114, in an opposing direction. The coil rotor 108 may rotate freely (e.g., independently) with respect to the first magnetic rotor 102 and the second magnetic rotor 114. The coil rotor 108 may be rotated using, for example, a second shaft, a second motor, a gear box (e.g., the gear box 500), a planetary gear assembly (e.g., the planetary gear assembly 716), or the like. The coil rotor 108 includes one or more coils 112. For example, in FIG. 15, four coils 112 are shown (e.g., the first coil 112A, the second coil 112B, the third coil 112C, and the fourth coil 112D).

The second magnetic rotor 114 may be rotationally connected to a shaft. The second magnetic rotor 114 may be rotated by the shaft, that is, a rotational force applied to the shaft may drive the second magnetic rotor 114. Rotational force may be applied to the shaft using, for example, a first motor, a wind turbine, a vehicle engine, or another rotation source. The second magnetic rotor 114 includes one or more outer magnets 118. For example, in FIG. 15, four outer magnets 118 are shown. The outer magnets 118 may be arranged to alternate polarity around the second magnetic rotor 114. For example, the first outer magnet 118A may be a first polarity (e.g., north), the second outer magnet 118B may be a second polarity (e.g., south), the third outer magnet 118C may be the first polarity (e.g., north), and the fourth outer magnet 118D may be the second polarity (e.g., south).

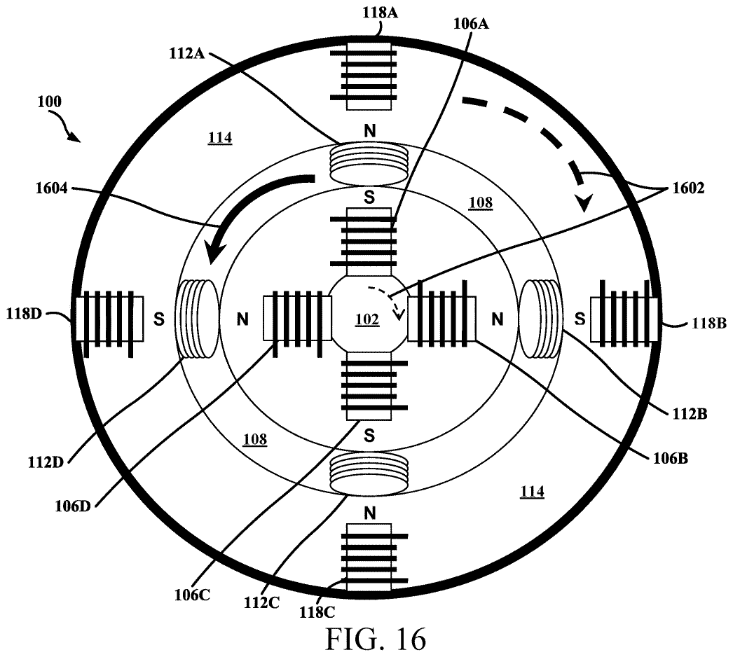

FIG. 16 is a cross-section of the tri-rotor generator 100 including electromagnets. A radial configuration of the tri-rotor generator 100 is shown in FIG. 16, however, an axial configuration may be used. The first magnetic rotor 102 includes one or more inner magnets 106 and the second magnetic rotor 114 includes one or more outer magnets 118. In the third example, the inner magnets 106 and the outer magnets 118 may be electromagnets. In a third example, the first magnetic rotor 102 may simulate rotation in a first direction 1602 (e.g., clockwise), the coil rotor 108 may physically rotate in a second direction 1604 (e.g., counterclockwise), and the second magnetic rotor 114 may simulate rotation in the first direction 1602 (e.g., clockwise).

The first magnetic rotor 102 may be physically stationary and include electromagnets as the inner magnets 106. The electromagnets (e.g., the inner magnets 106) may simulate rotation of the first magnetic rotor 102 in the first direction 1602 (e.g., clockwise). The rotating magnetic field to be created by the electromagnets may be derived electronically based on the coil rotor 108. In FIG. 16, four inner magnets 106 are shown as an example, but other configurations and/or quantities of electromagnets may be used.

The second magnetic rotor 114 may be physically stationary and include electromagnets as the outer magnets 118. The electromagnets (e.g., the outer magnets 118) may simulate rotation of the second magnetic rotor 114 in the same direction as the simulated rotation of the first magnetic rotor 102 (e.g., clockwise). The rotating magnetic field to be created by the electromagnets may be derived electronically based on the coil rotor 108. In FIG. 16, four outer magnets 118 are shown as an example, but other configurations and/or quantities of electromagnets may be used.

The electromagnets (e.g., the inner magnets 106 and the outer magnets 118) may be injected (e.g., supplied, fed) with time-varying current (e.g., sinusoidal, cosinusoidal, square wave, or the like). For example, the electromagnets may be injected with the current waveform 1300, a phase-shifted cosinusoidal current, the current digitized waveform 1400, a phase-shifted current digitized waveform, or the like. The time-varying currents supplied to the electromagnets may have a same frequency. Each electromagnet may be injected with a different phase of current based on a position of the electromagnet (e.g., a position around the first magnetic rotor 102 or a position around the second magnetic rotor 114). In implementations in which both the inner magnets 106 and the outer magnets 118 are electromagnets, electromagnets that are aligned across the coil rotor 108 (e.g., positioned opposite one another relative to a given coil) may be driven to produce opposite magnetic polarities at the coil. For example, the first outer magnet 118A and the first inner magnet 106A aligned with the first coil 112A may be driven such that one produces a north pole and the other produces a south pole at surfaces facing the first coil 112A. A direction of current supplied to each electromagnet may be selected based on winding orientation of the electromagnet (e.g., according to Lenz's law) to achieve the desired polarity. In this manner, coordinated excitation of the electromagnets may reinforce magnetic flux across the coils while maintaining a controlled rotating magnetic field.

The coil rotor 108 may be configured to rotate in a direction opposite the direction of rotation simulated by the first magnetic rotor 102 and the second magnetic rotor 114 (e.g., counterclockwise). The simulated rotation of the first magnetic rotor 102 and/or the second magnetic rotor 114 may be based on a speed of rotation of the coil rotor 108. The coil rotor 108 may rotate freely (e.g., independently) with respect to the first magnetic rotor 102 and the second magnetic rotor 114. The coil rotor 108 may be rotated using, for example, a shaft, a motor, a gear box (e.g., the gear box 500), a planetary gear assembly (e.g., the planetary gear assembly 716), or the like. The coil rotor 108 includes one or more coils 112. For example, in FIG. 16, four coils 112 are shown (e.g., the first coil 112A, the second coil 112B, the third coil 112C, and the fourth coil 112D).

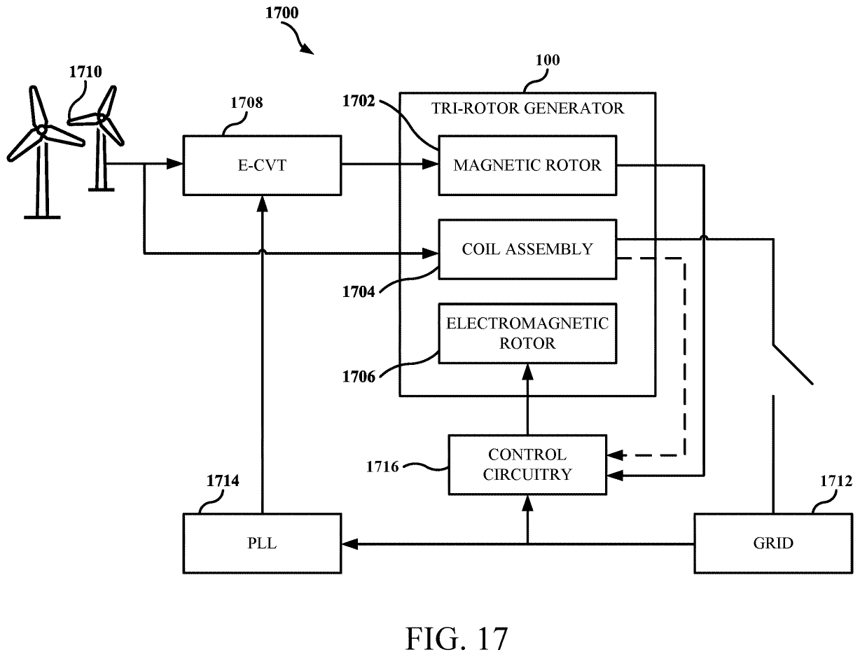

FIG. 17 is a system 1700 including the tri-rotor generator 100. The system 1700 may be configured as a grid-connected generation system, a microgrid interface system, or another regulated power generation platform in which electrical output parameters are actively synchronized with an external electrical system.

The system 1700 includes the tri-rotor generator 100. In this example, the tri-rotor generator 100 includes a magnetic rotor 1702 (e.g., the first magnetic rotor 102 or the second magnetic rotor 114), a coil assembly 1704 including coils (e.g., the coil rotor 108 including the coils 112), and an electromagnetic rotor 1706 (e.g., the first magnetic rotor 102 or the second magnetic rotor 114). The magnetic rotor 1702 may comprise one or more magnetic field sources, such as permanent magnets, and may physically rotate. The electromagnetic rotor 1706 may comprise one or more electromagnets configured to receive controlled excitation currents. The coil assembly 1704 may be disposed between the magnetic rotor 1702 and the electromagnetic rotor 1706.

The coil assembly 1704 may be implemented as a coil rotor. In some implementations, the coil rotor may rotate in a direction opposite a direction of rotation of the magnetic rotor 1702. Counter-rotating the coil rotor and the magnetic rotor 1702 may increase relative rotational speed between the coil assembly 1704 and a rotating magnetic field. In other implementations, the coil assembly 1704 may be selectively configurable between a stationary mode in which the coils are fixed relative to the magnetic rotor 1702 and a rotational mode in which the coil assembly 1704 rotates.

The system 1700 further includes a rotational control system configured to control rotation of the tri-rotor generator 100. The rotational control system may be configured to control rotation of the magnetic rotor 1702. In embodiments where the electromagnetic rotor 1706 is replaced with a second magnetic rotor, the rotational control system may be configured to control rotation of the magnetic rotor 1702 the second magnetic rotor, or both. In other embodiments, the rotational control system may be configured to control rotation of the magnetic rotor 1702, the coil assembly 1704, the second magnetic rotor, or any combination thereof. In the illustrated example, the rotational control system includes an electronic continuously variable transmission (E-CVT) 1708. The E-CVT 1708 may be mechanically (e.g., rotationally) coupled to the magnetic rotor 1702 and configured to regulate rotational frequency and phase of the magnetic rotor 1702. The E-CVT 1708 may receive rotational energy from a rotation source 1710. The rotation source 1710 may include, for example, a wind turbine, windmill, hydro turbine, engine, or other prime mover. In some examples, the rotation source 1710 may provide highly variable rotational speed (e.g., based on wind conditions, water conditions, or the like).

The E-CVT 1708 may receive variable-speed mechanical input and output a controlled rotational frequency and phase to the magnetic rotor 1702. In some implementations, the E-CVT 1708 may include a planetary gear assembly, one or more controllable motors coupled to a sun gear or planet carrier, and associated power electronics to control the frequency and phase of the magnetic rotor 1702. The E-CVT 1708 may maintain a desired rotational frequency of the magnetic rotor 1702 even when the rotation source 1710 varies.

The rotation source 1710 may be configured to rotate the coil assembly 1704. The coil assembly 1704 may be mechanically (e.g., rotationally) coupled to the rotation source 1710. In some examples, the coil assembly 1704 may be rotated at a variable rate based on the variable rotational speed provided by the rotation source 1710. The coils of the coil assembly 1704 may be electrically couplable to an external electrical system, such as a grid 1712. The grid 1712 may be an electrical grid operating at a defined nominal frequency (e.g., 50 Hz or 60 Hz) and voltage amplitude. The grid 1712 may impose requirements on frequency, phase, and amplitude of injected current.

The rotational control system (e.g., the E-CVT 1708) may be configured to synchronize a frequency and a phase of a voltage induced in the coils of the coil assembly 1704 with the grid 1712. The system 1700 may include a phase-locked loop (PLL) 1714. The PLL 1714 may receive an input signal from the grid 1712 representative of grid frequency and phase. The PLL 1714 may output a control signal indicative of a target rotational frequency and phase. The E-CVT 1708 may receive the PLL output and adjust mechanical rotation of the magnetic rotor 1702 accordingly such that the electrical frequency and phase of the voltage induced in the coils of the coil assembly 1704 are synchronized with the grid 1712.

The system 1700 further includes control circuitry 1716 configured to apply current to the electromagnetic rotor 1706. The control circuitry 1716 may include inverters, switching devices, digital controllers, and/or amplifiers configured to inject time-varying currents into the electromagnets of the electromagnetic rotor 1706. The control circuitry 1716 may sense an angular position of the magnetic rotor 1702 and/or the coil assembly 1704. Angular position may be sensed using encoders, Hall-effect sensors, resolvers, optical sensors, or other rotational position sensing devices coupled to the magnetic rotor 1702, the coil assembly 1704, or another portion of the tri-rotor generator 100. The sensed angular position may be provided to the control circuitry 1716 to regulate excitation currents supplied to the electromagnets. The angular position may enable synchronization of the rotating magnetic field generated by the electromagnetic rotor 1706 with mechanical position of the magnetic rotor 1702 and/or coil assembly 1704. By controlling magnitude, frequency, and phase of the excitation currents supplied to the electromagnetic rotor 1706, the control circuitry 1716 may generate a rotating magnetic field that interacts with the magnetic rotor 1702 and the coils of the coil assembly 1704.

The control circuitry 1716 may include an amplitude sensor configured to sense an amplitude of the grid voltage. The control circuitry 1716 may regulate an amplitude of the induced voltage in the coils of the coil assembly 1704. The amplitude sensor may receive a signal representative of grid voltage amplitude and provide a corresponding reference to the control circuitry 1716. Based on this reference, the control circuitry 1716 may adjust the amplitude of current supplied to the electromagnets of the electromagnetic rotor 1706 to synchronize the amplitude of the voltage induced in the coils of the coil assembly 1704 with the grid 1712.

Accordingly, the rotational control system (e.g., the E-CVT 1708) may regulate mechanical speed to control electrical frequency and phase, while the control circuitry 1716 regulating excitation of the electromagnetic rotor 1706 may control voltage amplitude. Through coordinated operation of the E-CVT 1708, the PLL 1714, and the control circuitry 1716, the tri-rotor generator 100 may produce output power having frequency, phase, and amplitude substantially matched to those of the grid 1712.

In operation, mechanical energy from the rotation source 1710 drives the E-CVT 1708. The E-CVT 1708 controls rotation of the magnetic rotor 1702 to maintain synchronization with the grid 1712 based on feedback from the PLL 1714. Simultaneously, the control circuitry 1716 adjusts excitation of the electromagnetic rotor 1706 based on amplitude feedback from the amplitude sensor. The resulting induced current in the coils of the coil assembly 1704 may therefore be synchronized in frequency and phase and regulated in amplitude to meet grid requirements. As a result, the tri-rotor generator 100 may be directly connected to the grid 1712. The tri-rotor generator 100 may be connected to the grid 1712 without requiring a grid-tie inverter. The tri-rotor generator 100 may be directly connected to the grid 1712 because synchronization and amplitude regulation are achieved through coordinated mechanical and electromagnetic control within the system 1700.

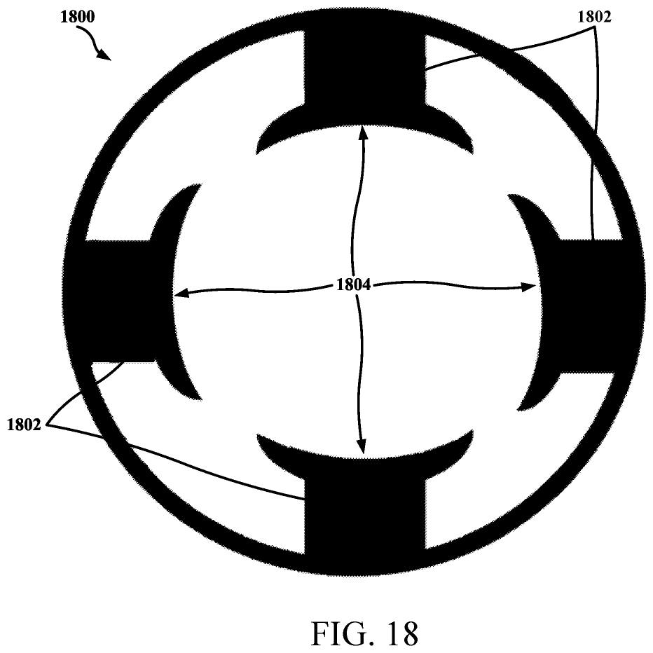

FIG. 18 illustrates a magnetic rotor 1800 containing electromagnets 1802. The magnetic rotor 1800 may be used as an outer rotor of the tri-rotor generator 100 (e.g., as the second magnetic rotor 114). In another example, the magnetic rotor 1800 may be used as an inner rotor (e.g., the first magnetic rotor 102).

The electromagnets 1802 may be shaped with an increased surface area proximate to a coil (e.g., the coils 112). The electromagnets 1802 may have a curved face 1804 proximate to the coil. The curved face 1804 may be, for example, convex, as shown in FIG. 18. The shape of the electromagnets 1802 may be tailored to increase an efficiency of the magnetic field generated between the first magnetic rotor 102 and the magnetic rotor 1800.

In another example, the electromagnets 1802 may be used on an inner rotor of the tri-rotor generator 100 (e.g., the first magnetic rotor 102). When used on an inner rotor, the curved face 1804 of the electromagnets 1802 may be curved in an opposite direction (e.g., concave). The shapes shown in FIG. 18 are illustrative examples, and other shapes, geometries, or surface profiles of the electromagnets 1802 may be used. For example, the electromagnets 1802 may have flat faces, stepped profiles, tapered profiles, or other contours selected based on desired magnetic field distribution, manufacturing considerations, or performance characteristics.

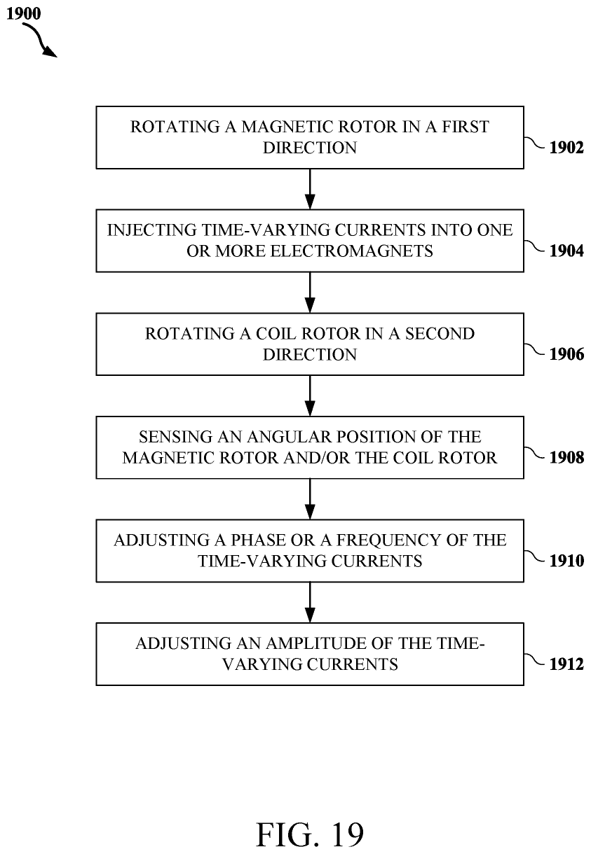

FIG. 19 is a flowchart of a method 1900 of operating a tri-rotor generator, for example, the tri-rotor generator 100. The method 1900 corresponds to operation of a tri-rotor generator including a magnetic rotor, a coil rotor, and one or more electromagnets. The steps of the method 1900 may be performed using the structural components previously described. For example, the magnetic rotor may be the first magnetic rotor 102, the coil rotor may be the coil rotor 108, and the one or more electromagnets may be the outer magnets 118 implemented as electromagnets on the second magnetic rotor 114.

At step 1902, the magnetic rotor is rotated in a first direction. The magnetic rotor may include one or more permanent magnets and may be mechanically driven by a shaft, motor, wind turbine, engine, or an E-CVT (e.g., the E-CVT 1708). Rotating the magnetic rotor in the first direction may generate a rotating magnetic field relative to the coil rotor, thereby contributing to induction of voltage in one or more coils of the coil rotor.

At step 1904, time-varying currents are injected (e.g., supplied, fed) into the one or more electromagnets to generate a rotating magnetic field. The rotating magnetic field produced by the electromagnets may be in the first direction relative to the coil rotor (e.g., in a same direction as the rotating magnetic field generated by the magnetic rotor). The time-varying currents may be sinusoidal, cosinusoidal, phase-shifted, digitized waveforms, or other controlled waveforms, and may be supplied by control circuitry including inverters, switching devices, and digital controllers. Injecting the time-varying currents may allow the electromagnets to produce a rotating magnetic field that is coordinated with mechanical rotation of the magnetic rotor.

At step 1906, the coil rotor is rotated in a second direction. The second direction may be opposite the first direction of the magnetic rotor. Rotating the coil rotor in the second direction may increase relative rotational speed between the coils and the rotating magnetic field. Rotation of the coil rotor may be accomplished using a gear box (e.g., the gear box 500), a planetary gear assembly (e.g., the planetary gear assembly 716), an E-CVT, or another mechanical coupling. In some implementations, the coil rotor may rotate at a same speed (e.g., magnitude of speed) as the magnetic rotor but in an opposite direction (e.g., counter rotation). In other implementations, the coil rotor may rotate at a different speed (e.g., magnitude of speed) and in an opposite direction (e.g., counter rotation) as the magnetic rotor.

At step 1908, an angular position of the magnetic rotor and/or the coil rotor is sensed. Angular position may be sensed using encoders, Hall-effect sensors, resolvers, optical sensors, or other rotational position sensing devices coupled to the magnetic rotor, the coil rotor, or another portion of the tri-rotor generator. The sensed angular position may be provided to control circuitry configured to regulate excitation currents supplied to the electromagnets. Sensing the angular position may enable synchronization of the rotating magnetic field with mechanical position of the magnetic rotor and/or coil rotor.

At step 1910, a phase or a frequency of the time-varying currents is adjusted. The phase or frequency may be adjusted based on the angular position of the magnetic rotor and/or the coil rotor. The control circuitry may modify phase and/or frequency of the excitation currents in real time to maintain a desired relationship between the rotating magnetic field generated by the electromagnets and the mechanical position of the rotors. In grid-connected implementations, such adjustments may also be coordinated with a PLL (e.g., the PLL 1714) to synchronize electrical output with an external electrical system.

At step 1912, an amplitude of the time-varying currents is adjusted. Adjusting the amplitude of the time-varying currents may regulate an amplitude of a voltage induced in the coil rotor. The amplitude of the excitation currents may be increased to increase magnetic field strength and corresponding induced voltage magnitude, or decreased to reduce induced voltage magnitude. In grid-connected implementations, amplitude adjustment may be performed in response to an amplitude sensor or amplitude control module (e.g., the control circuitry 1716) to synchronize induced voltage amplitude with a required grid voltage.

The steps of the method 1900 may be performed sequentially or concurrently. The steps of the method 1900 may be performed in a continuous control loop during operation of the tri-rotor generator 100. In some examples, only some of the steps of the method 1900 are performed and other steps are omitted. By coordinating mechanical rotation of the magnetic rotor, optional counter-rotation of the coil rotor, sensing of angular position, and dynamic control of phase, frequency, and amplitude of excitation currents, the tri-rotor generator may generate electrical power with controlled frequency, phase, and amplitude characteristics suitable for direct connection to loads or external electrical systems.

Example A is a tri-rotor generator including a first magnetic rotor with one or more magnetic field sources, a second magnetic rotor with one or more magnetic field sources, and a coil rotor with two or more electrical coils, wherein the coil rotor is disposed between the first magnetic rotor and the second magnetic rotor.

Example B is the tri-rotor generator of example A, further including a shaft, wherein the first magnetic rotor and the second magnetic rotor are rotationally connected to the shaft.

Example C is the tri-rotor generator of example A, wherein each of the one or more magnetic field sources is a permanent magnet or an electromagnet.

Example D is the tri-rotor generator of example A, wherein the first magnetic rotor, the second magnetic rotor, and the coil rotor are rotationally connected to a motor through a gear box.

Example E is the tri-rotor generator of example D, wherein the gear box is a planetary gear assembly, the planetary gear assembly including a sun gear rotationally connected to the first magnetic rotor and the second magnetic rotor, and a ring gear rotationally connected to the coil rotor.

Example F is the tri-rotor generator of example E, further including a first shaft rotationally connected to the sun gear, wherein rotation of the first shaft causes the first magnetic rotor and the second magnetic rotor to rotate in a first direction and causes the coil rotor to rotate in a second direction, and a second shaft rotationally connected to a planet carrier of the planetary gear assembly.

Example G is the tri-rotor generator of example A, wherein the two or more electrical coils include four coils associated with a first phase and four coils associated with a second phase, the four coils associated with the first phase are connected in series and terminate in a first wire and a second wire, and the four coils associated with the second phase are connected in series and terminate in a third wire and a fourth wire.

Example H is the tri-rotor generator of example G, further including a first brush electrically connected to the first wire, a second brush electrically connected to the second wire, a third brush electrically connected to the third wire, and a fourth brush electrically connected to the fourth wire.

Example I is a tri-rotor generator including a first magnetic rotor rotationally connected to a sun gear of a planetary gear assembly, a second magnetic rotor rotationally connected to the sun gear, a coil rotor rotationally connected to a ring gear of the planetary gear assembly, wherein the coil rotor is disposed between the first magnetic rotor and the second magnetic rotor, and a first shaft rotationally connected to the ring gear, wherein rotation of the first shaft causes the ring gear and the coil rotor to rotate in a first direction and causes the sun gear, the first magnetic rotor, and the second magnetic rotor to rotate in a second direction.

Example J is the tri-rotor generator of example I, further including a second shaft rotationally connected to a planet carrier of the planetary gear assembly, and a motor rotationally connected to the second shaft.

Example K is the tri-rotor generator of example J, wherein the motor is configured to control rotation of the sun gear and the ring gear to maintain a constant electrical output frequency.

Example L is the tri-rotor generator of example K, wherein the motor is configured to rotate the second shaft in response to changes in rotation of the first shaft.

Example M is the tri-rotor generator of example I, wherein the first magnetic rotor, the second magnetic rotor, and the coil rotor are arranged in an axial direction of the first shaft.

Example N is a tri-rotor generator including an inner rotor rotationally connected to a shaft, a middle rotor with two or more coils, wherein a first portion of the middle rotor at least partially surrounds at least a portion of the inner rotor and a second portion of the middle rotor extends beyond the inner rotor in an axial direction, and an outer rotor, wherein the outer rotor at least partially surrounds the first portion of the middle rotor, and the outer rotor and the inner rotor each include one or more magnetic field sources.

Example O is the tri-rotor generator of example N, wherein the outer rotor is rotationally connected to the shaft.

Example P is the tri-rotor generator of example N, wherein the outer rotor is rotationally connected to the inner rotor such that the outer rotor rotates synchronously and in a same direction as the inner rotor.

Example Q is the tri-rotor generator of example N, wherein the middle rotor is rotationally connected to at least one gear rotationally connected to the shaft.

Example R is the tri-rotor generator of example N, wherein the inner rotor, the middle rotor, and the outer rotor are rotationally connected to a motor through a gear box.

Example S is the tri-rotor generator of example R, wherein the gear box includes bevel gears.

Example T is the tri-rotor generator of example R, wherein the gear box includes a full mode wherein the inner rotor, the middle rotor, and the outer rotor are rotationally connected to the motor and a reduced mode wherein one or more of the inner rotor, the middle rotor, and the outer rotor are not rotationally connected to the motor.

Example U is the tri-rotor generator of example N, wherein the two or more coils are electrically connected to brushes on the second portion of the middle rotor.

Example V is the tri-rotor generator of example N, wherein each of the one or more magnetic field sources is a permanent magnet.

Example W is the tri-rotor generator of example N, wherein each of the one or more magnetic field sources is an electromagnet.

Example X is the tri-rotor generator of example N, wherein the inner rotor includes eight magnetic field sources and the outer rotor includes eight magnetic field sources.

Example Y is the tri-rotor generator of example N, wherein the middle rotor rotates independently with respect to the inner rotor and the outer rotor.

Example Z is the tri-rotor generator of example N, wherein the shaft is rotationally connected to a first motor and the middle rotor is rotationally connected to a second motor.

Example AA is the tri-rotor generator of example Z, wherein the middle rotor is rotationally connected to a timing pulley, a spur gear, or a V-belt.

Example AB is the tri-rotor generator of example N, wherein the inner rotor is rotatable in a first direction, the middle rotor is rotatable in a second direction, and the outer rotor is rotatable in the first direction.

Example AC is the tri-rotor generator of example N, wherein the two or more coils include eight coils.

Example AD is the tri-rotor generator of example N, wherein the two or more coils are separated into two phases.

Example AE is the tri-rotor generator of example N, wherein the two or more coils include four coils associated with a first phase and four coils associated with a second phase, the four coils associated with the first phase comprise a first wire containing two coils and a second wire containing two coils, and the four coils associated with the second phase includes a third wire containing two coils and a fourth wire containing two coils.

Example AF is the tri-rotor generator of example AE, further including a first brush electrically connected to the first wire, a second brush electrically connected to the second wire, a third brush electrically connected to the third wire, and a fourth brush electrically connected to the fourth wire.

Example AG is the tri-rotor generator of example N, wherein the two or more coils include four coils.

Example AH is a generator, including a first magnetic field assembly including one or more electromagnets, a second magnetic field assembly, a coil assembly including one or more coils, wherein the coil assembly is disposed between the first magnetic field assembly and the second magnetic field assembly, and control circuitry configured to apply current to the first magnetic field assembly to generate a rotating magnetic field relative to the coil assembly.

Example AI is the tri-rotor generator of example AH, wherein the second magnetic field assembly includes one or more electromagnets, and the control circuitry is further configured to apply current to the second magnetic field assembly to generate a magnetic field that combines with the rotating magnetic field relative to the coil assembly.

Example AJ is the tri-rotor generator of example AH, wherein the second magnetic field assembly is a magnetic rotor including one or more permanent magnets.

Example AK is the tri-rotor generator of example AJ, wherein the control circuitry is configured to adjust at least one of a phase or a frequency of the current based on an angular position of the magnetic rotor.

Example AL is the tri-rotor generator of example AH, wherein the coil assembly is a coil rotor configured to rotate in a direction opposite a direction of the rotating magnetic field.

Example AM is the tri-rotor generator of example AL, wherein the control circuitry is configured to adjust at least one of a phase or a frequency of the current based on an angular position of the coil rotor.

Example AN is the tri-rotor generator of example AH, wherein the coil assembly is a coil rotor selectively configurable between a stationary mode in which the coil assembly is fixed relative to a housing and a rotational mode in which the coil assembly rotates relative to the first magnetic field assembly to increase a relative rotational speed between the coil assembly and the rotating magnetic field.

Example AO is the tri-rotor generator of example AH, wherein the control circuitry is configured to synchronize a frequency and a phase of a voltage induced in the coil assembly with an external electrical system.

Example AP is the tri-rotor generator of example AH, wherein the control circuitry is configured to adjust an amplitude of the current to regulate an amplitude of a voltage induced in the coil assembly.

Example AQ is a system including a generator. The generator includes a magnetic rotor including one or more magnetic field sources, a magnetic field assembly including one or more electromagnets, and a coil assembly disposed between the magnetic rotor and the magnetic field assembly. The coil assembly includes one or more coils electrically couplable to an external electrical system. The system further includes a rotational control system configured to control rotation of the magnetic rotor to synchronize a frequency and a phase of a voltage induced in the one or more coils with the external electrical system. The system further includes control circuitry configured to apply current to the magnetic field assembly to synchronize an amplitude of the voltage induced in the one or more coils with the external electrical system.

Example AR is the tri-rotor generator of example AQ, wherein the system further includes a phase-locked loop configured to receive an input signal from the external electrical system and output a frequency and a phase to the rotational control system.

Example AS is the tri-rotor generator of example AQ, wherein the coil assembly is a coil rotor, and the rotational control system is configured to rotate the coil rotor in a direction opposite a direction of rotation of the magnetic rotor.

Example AT is the tri-rotor generator of example AQ, wherein the coil assembly is a coil rotor selectively configurable between a stationary mode in which the coil assembly is fixed relative to the magnetic rotor and a rotational mode in which the coil assembly rotates relative to the magnetic field assembly to increase a relative rotational speed between the coil assembly and a rotating magnetic field generated by the one or more electromagnets.

Example AU is the tri-rotor generator of example AQ, wherein the rotational control system receives rotational energy from an external rotation source.

Example AV is the tri-rotor generator of example AU, wherein the external rotation source is a wind turbine.

Example AW is the tri-rotor generator of example AQ, wherein the rotational control system is an electronic continuously variable transmission.

Example AX is the tri-rotor generator of example AQ, wherein the external electrical system is an electrical grid.

Example AY is a method of operating a generator including a magnetic rotor, a coil rotor, and one or more electromagnets. The method includes rotating the magnetic rotor in a first direction, injecting, into the one or more electromagnets, time-varying currents to generate a rotating magnetic field in the first direction relative to the coil rotor, sensing an angular position of the magnetic rotor, and adjusting, based on the angular position of the magnetic rotor, at least one of a phase or a frequency of the time-varying currents.

Example AZ is the tri-rotor generator of example AY, wherein the method further includes rotating the coil rotor in a second direction, and sensing an angular position of the coil rotor, wherein adjusting at least one of the phase or the frequency of the time-varying currents is based on the angular position of the coil rotor.

Example AAA is the tri-rotor generator of example AY, wherein the method further includes adjusting an amplitude of the time-varying currents to regulate an amplitude of a voltage induced in the coil rotor.

What is claimed is:

1. A generator, comprising:
a first magnetic field assembly comprising one or more electromagnets;
a second magnetic field assembly;
a coil assembly comprising one or more coils, wherein the coil assembly is disposed between the first magnetic field assembly and the second magnetic field assembly; and
control circuitry configured to apply current to the first magnetic field assembly to generate a rotating magnetic field relative to the coil assembly.

2. The generator of claim 1, wherein:
the second magnetic field assembly comprises one or more electromagnets; and
the control circuitry is further configured to apply current to the second magnetic field assembly to generate a magnetic field that combines with the rotating magnetic field relative to the coil assembly.

3. The generator of claim 1, wherein the second magnetic field assembly is a magnetic rotor comprising one or more permanent magnets.

4. The generator of claim 3, wherein the control circuitry is configured to adjust at least one of a phase or a frequency of the current based on an angular position of the magnetic rotor.

5. The generator of claim 1, wherein the coil assembly is a coil rotor configured to rotate in a direction opposite a direction of the rotating magnetic field.

6. The generator of claim 5, wherein the control circuitry is configured to adjust at least one of a phase or a frequency of the current based on an angular position of the coil rotor.

7. The generator of claim 1, wherein the coil assembly is a coil rotor selectively configurable between a stationary mode in which the coil assembly is fixed relative to a housing and a rotational mode in which the coil assembly rotates relative to the first magnetic field assembly to increase a relative rotational speed between the coil assembly and the rotating magnetic field.

8. The generator of claim 1, wherein the control circuitry is configured to synchronize a frequency and a phase of a voltage induced in the coil assembly with an external electrical system.

9. The generator of claim 1, wherein the control circuitry is configured to adjust an amplitude of the current to regulate an amplitude of a voltage induced in the coil assembly.

10. A system, comprising:
a generator, comprising:
a magnetic rotor comprising one or more magnetic field sources;
a magnetic field assembly comprising one or more electromagnets; and
a coil assembly disposed between the magnetic rotor and the magnetic field assembly, wherein the coil assembly comprises one or more coils electrically couplable to an external electrical system;
a rotational control system configured to control rotation of the magnetic rotor to synchronize a frequency and a phase of a voltage induced in the one or more coils with the external electrical system; and
control circuitry configured to apply current to the magnetic field assembly to synchronize an amplitude of the voltage induced in the one or more coils with the external electrical system.

11. The system of claim 10, further comprising:
a phase-locked loop configured to receive an input signal from the external electrical system and output a frequency and a phase to the rotational control system.

12. The system of claim 10, wherein:
the coil assembly is a coil rotor; and
the rotational control system is configured to rotate the coil rotor in a direction opposite a direction of rotation of the magnetic rotor.

13. The system of claim 10, wherein the coil assembly is a coil rotor selectively configurable between a stationary mode in which the coil assembly is fixed relative to the magnetic rotor and a rotational mode in which the coil assembly rotates relative to the magnetic field assembly to increase a relative rotational speed between the coil assembly and a rotating magnetic field generated by the one or more electromagnets.

14. The system of claim 10, wherein the rotational control system receives rotational energy from an external rotation source.

15. The system of claim 14, wherein the external rotation source is a wind turbine.

16. The system of claim 10, wherein the rotational control system is an electronic continuously variable transmission.

17. The system of claim 10, wherein the external electrical system is an electrical grid.

18. A method of operating a generator comprising a magnetic rotor, a coil rotor, and one or more electromagnets, the method comprising:
rotating the magnetic rotor in a first direction;
injecting, into the one or more electromagnets, time-varying currents to generate a rotating magnetic field in the first direction relative to the coil rotor;
sensing an angular position of the magnetic rotor; and
adjusting, based on the angular position of the magnetic rotor, at least one of a phase or a frequency of the time-varying currents.

19. The method of claim 18, further comprising:
rotating the coil rotor in a second direction; and
sensing an angular position of the coil rotor, wherein adjusting at least one of the phase or the frequency of the time-varying currents is based on the angular position of the coil rotor.

20. The method of claim 18, further comprising:
adjusting an amplitude of the time-varying currents to regulate an amplitude of a voltage induced in the coil rotor.
